(19) United States
(12) Patent Application Publication
(10) Pub. No.: US 2024/0326292 A1
(43) Pub. Date: Oct. 3, 2024

(54) PIEZOELECTRIC POWDER PARTICULATES FOR ADDITIVE MANUFACTURING AND METHODS ASSOCIATED THEREWITH

(71) Applicant: Xerox Corporation, Norwalk, CT (US)

(72) Inventors: Sarah J. VELLA, Milton (CA); Alexandros VASILEIOU, Toronto (CA); Yujie ZHU, Mississauga (CA); Edward G. ZWARTZ, Mississauga (CA)

(73) Assignee: Xerox Corporation, Norwalk, CT (US)

(21) Appl. No.: 18/291,037

(22) PCT Filed: Jul. 18, 2022
(86) PCT No.: PCT/US2022/037477

§ 371 Date: Jan. 22, 2024

Related U.S. Application Data
(60) Provisional application No. 63/224,445, filed on Jul. 22, 2021.

(51) Int. Cl. B29B 9/12; B29C 64/153; B29K 105/00; B29K 509/00; B33Y 10/00; B33Y 70/00

(52) U.S. Cl. CPC B29B 9/12; B29C 64/153; B33Y 10/00; B33Y 70/00; B29B 2009/125; B29K 2105/251; B29K 2509/00; B29K 2995/0003

(57) ABSTRACT

Parts made by additive manufacturing are often structural in nature, rather than having functional properties conveyed by a polymer or other component present therein. Printed parts having piezoelectric properties may be formed using powder particulates comprising a thermoplastic polymer and piezoelectric particles, wherein the piezoelectric particles are located (i) in the thermoplastic polymer at an outer surface of the powder particulates, (ii) within a core of the powder particulates, or (iii) combinations thereof. Additive manufacturing processes, such as powder bed fusion of powder particulates, may be employed to form printed objects in a range of shapes from the powder particulates. Melt emulsification may be used to form the powder particulates.

### FIELD

The present disclosure generally relates to additive manufacturing and, more particularly, additive manufacturing processes employing powder bed fusion (PBF) and similar particulate consolidation processes, such as those employing selective laser sintering for producing complex objects and particulate compositions useful therein.

### BACKGROUND

Additive manufacturing, also known as three-dimensional (3-D) printing, is a rapidly growing technology area. Although additive manufacturing has traditionally been used for rapid prototyping activities, this technique is being increasingly employed for producing commercial and industrial parts (printed objects) in any number of complex shapes. Additive manufacturing processes operate by layer-by-layer deposition of either 1) a stream of molten printing material or a liquid precursor to a printing material or 2) powder particulates of a printing material. The layer-by-layer deposition usually takes place under control of a computer to deposit and consolidate the printing material in precise locations based upon a digital three-dimensional “blueprint” (a computer-aided design model) of the part to be manufactured. Consolidation of powder particulates may take place in a powder bed deposited layer-by-layer using a three-dimensional printing system that employs a laser or electron beam to heat precise locations of the powder bed, thereby consolidating specified powder particulates to form a part having a desired shape. Selective laser sintering (SLS) employs a laser to promote consolidation of powder particulates via localized heating. Other techniques suitable for promoting consolidation of powder particulates through localized heating include, for example, Powder Bed Fusion (PBF), Electron Beam Melting (EBM), Binder Jetting and Multi-Jet Fusion (MJF).

Among the powder particulates usable in three-dimensional printing are those comprising thermoplastic polymers. Although a wide array of thermoplastic polymers are known, there are relatively few having properties compatible for use in current three-dimensional printing techniques, particularly when performing particulate consolidation by selective laser sintering and similar techniques. Thermoplastic polymers suitable for consolidation by selective laser sintering include those having a significant difference between the onset of melting and the onset of crystallization, which may promote good structural and mechanical integrity. Poor sphericity and inadequate powder flow characteristics are two limitations associated with many thermoplastic powder particulates currently used in three-dimensional printing processes.

A wide range of parts having various shapes may be fabricated through particulate consolidation. In many instances, the thermoplastic polymers employed may be largely structural in nature, rather than the thermoplastic polymer itself having innate functionality. One exception is weak electrical conductivity for electrically conductive polymers. Another exception is piezoelectric functionality, which may be present in printed objects formed from the β-form of polyvinylidene difluoride (PVDF), a polymer which possesses innate piezoelectricity upon poling. Piezoelectric materials generate charge under mechanical strain or, conversely, undergo mechanical strain when a potential is applied thereto. Potential applications for piezoelectric materials include sensing (e.g., pressure sensing), switching, actuation, and energy harvesting.

Beyond polyvinylidene difluoride, there are limited options for forming printed parts having piezoelectric properties by any type of additive manufacturing technique. Moreover, the piezoelectricity of polyvinylidene difluoride is rather low compared to other types of piezoelectric materials. Numerous ceramic materials having high piezoelectricity are available, such as lead-zirconium-titanate (PZT), but they are not printable as powder particulates by themselves and are often very brittle. Moreover, high sintering temperatures (>300° C.) may be needed to promote part consolidation after depositing predominantly a piezoelectric ceramic. These shortcomings may limit the range of printed parts having a piezoelectric response that may be obtained through present additive manufacturing processes.

Admixtures of polymers and piezoelectric particles in composite materials have not yet afforded high piezoelectric performance in printed parts. Poor dispersion of the piezoelectric particles in the polymer, piezoelectric particle agglomeration, and limited interactions between the piezoelectric particles and the polymer are to blame in many instances. Without being bound by any theory, the limited interactions between the piezoelectric particles and the polymer result in poor load transfer to the piezoelectric particles, thereby lowering the piezoelectric response obtained therefrom when mechanical strain is applied. Particle agglomeration may also play a role in this regard. These difficulties are further compounded by the difficulty in formulating polymer composites into a suitable particulate form compatible with particle-based three-dimensional printing processes.

### SUMMARY

The present disclosure provides particulate compositions suitable for additive manufacturing. The particulate compositions comprise: a plurality of powder particulates comprising a thermoplastic polymer and a plurality of piezoelectric particles, wherein the piezoelectric particles are located (i) in the thermoplastic polymer at an outer surface of the powder particulates, (ii) within a core of the powder particulates, or (iii) combinations thereof.

The present disclosure also provides printed objects formed using the particulate compositions. The printed objects comprise: a polymer matrix formed by particulate consolidation and comprising a thermoplastic polymer; and a plurality of piezoelectric particles located in the polymer matrix.

The present disclosure also provides methods for forming printed objects by powder bed fusion, such as through selective laser sintering. The methods comprise: depositing in a powder bed a particulate composition comprising a plurality of powder particulates comprising a thermoplastic polymer and a plurality of piezoelectric particles, wherein the piezoelectric particles are located (i) in the thermoplastic polymer at an outer surface of the powder particulates, (ii) within a core of the powder particulates, or (iii) combinations thereof; and consolidating a portion of the plurality of powder particulates in the powder bed to form a printed object.

The present disclosure also provides methods for forming particulate compositions suitable for additive manufacturing. The methods comprise: providing a composite comprising a thermoplastic polymer and a plurality of piezoelectric particles distributed in the thermoplastic polymer; combining the composite in a carrier fluid at a heating temperature at or above a melting point or softening temperature of the thermoplastic polymer; wherein the thermoplastic polymer and the carrier fluid are substantially immiscible at the heating temperature; applying sufficient shear to disperse the thermoplastic polymer as liquefied droplets containing the piezoelectric particles at the heating temperature; after liquefied droplets have formed, cooling the carrier fluid to at least a temperature at which powder particulates in a solidified state form, the powder particulates comprising the thermoplastic polymer and at least a portion of the piezoelectric particles, wherein the piezoelectric particles are located (i) in the thermoplastic polymer at an outer surface of the powder particulates, (ii) within a core of the powder particulates, or (iii) combinations thereof; and separating the powder particulates from the carrier fluid.

Methods for forming particulate compositions suitable for additive manufacturing may alternately comprise: combining a thermoplastic polymer and a plurality of piezoelectric particles in a carrier fluid at a heating temperature at or above a melting point or softening temperature of the thermoplastic polymer; wherein the thermoplastic polymer and the carrier fluid are substantially immiscible at the heating temperature; applying sufficient shear to disperse the thermoplastic polymer as liquefied droplets containing the piezoelectric particles at the heating temperature; after liquefied droplets have formed, cooling the carrier fluid to at least a temperature at which powder particulates in a solidified state form, the powder particulates comprising the thermoplastic polymer and at least a portion of the piezoelectric particles, wherein the piezoelectric particles are located (i) in the thermoplastic polymer at an outer surface of the powder particulates, (ii) within a core of the powder particulates, or (iii) combinations thereof; and separating the powder particulates from the carrier fluid.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, as will occur to one having ordinary skill in the art and having the benefit of this disclosure.

FIG. 1 is a cross-sectional diagram of an illustrative powder particulate in accordance with the present disclosure.

FIG. 2 is a flow chart of a non-limiting example method for producing powder particulates in accordance with the present disclosure.

FIGS. 3A-3C are SEM images of PCL:PZT powder particulates at various magnifications.

FIG. 4 is an SEM image of TPU:PZT powder particulates.

FIG. 5 is a cross-sectional SEM image of TPU:PZT powder particulates.

### DETAILED DESCRIPTION

The present disclosure generally relates to additive manufacturing and, more particularly, additive manufacturing processes employing powder bed fusion (PBF) and similar particulate consolidation processes, such as those employing selective laser sintering for producing complex objects and particulate compositions useful therein.

As discussed above, additive manufacturing processes, such as those employing selective laser sintering and other particulate consolidation processes to promote powder bed fusion, are capable of producing parts (printed objects) in a wide range of complex shapes. At present, the polymers present in powder particulates used for additive manufacturing are largely structural in nature and do not convey functional properties to a printed part by themselves. The β-form of polyvinylidene difluoride is a notable exception, which may convey piezoelectricity to printed parts after poling. Beyond polyvinylidene difluoride, there are few choices for introducing piezoelectricity into printed parts. Furthermore, the magnitude of the piezoelectric effect achievable with polyvinylidene difluoride may not be sufficiently large for some intended applications.

In response to the foregoing shortcomings, the present disclosure provides powder particulates that may be suitable for undergoing powder bed fusion and similar particulate consolidation processes to afford printed parts having significant piezeoelectricity, after poling. Namely, the powder particulates disclosed herein include a thermoplastic polymer and piezoelectric particles associated with the thermoplastic polymer, which collectively define a composite in fine particulate form. The piezoelectric particles may be mixed or located in the thermoplastic polymer and localize at an outer surface of the powder particulates (i.e., at an interface between the thermoplastic polymer and another substance or the external environment), reside within a core of the powder particulates, or combinations thereof. In addition to affording piezoelectricity, suitable materials for inclusion in the powder particulates disclosed herein may include those that form parts that are easily separable from a print bed, have sufficient mechanical strength once printed, and exhibit good interlayer adhesion.

Powder particulates of the present disclosure comprise a composite including piezoelectric particles and a thermoplastic polymer, which may be formed through melt emulsification processes described further herein. Advantageously, a number of thermoplastic polymers may be utilized for this purpose, which may extend the range of suitable use conditions for printed parts exhibiting piezoelectricity beyond those compatible with polyvinylidene difluoride. The thermoplastic polymer and the piezoelectric particles may be pre-processed into a melt blended composite before being further converted into powder particulates through melt emulsification. Suitable melt blending processes may include melt mixing of the thermoplastic polymer and the piezoelectric particles with stirring, followed by extrusion of the resulting melt blend, or through direct blending via extrusion with a twin-screw extruder, to form the melt blended composite. Optionally, the melt blended composites may then be ground, pulverized, or shredded (e.g., through cryo-milling), and the resulting composite residue may then be further processed through melt emulsification into the powder particulates, as discussed further herein. Alternately, the thermoplastic polymer and the piezoelectric particles may be directly processed into powder particulates through melt emulsification without first being compounded into a melt blended composite. Powder particulates having minimal to no void formation and minimal to no agglomeration of the piezoelectric particles may be realized, which may afford improved piezoelectric performance after poling a printed part formed from the powder particulates. A uniform distribution of the piezoelectric particles mixed in the thermoplastic polymer of the powder particulates may be realized in some instances, and/or at least a portion of the piezoelectric particles may be localized at an outer surface of the powder particulates or within a core of the powder particulates. That is, a non-uniform distribution of the piezoelectric particles may occur in some instances. Advantageously, the melt blending and melt emulsification processes may be conducted without exposure to a solvent, which may otherwise lead to incorporation of minor amounts of trace organic solvents remaining in the powder particulates. High loadings of piezoelectric particles mixed in the thermoplastic polymer of the powder particulates may also be realized, which, in combination with the piezoelectric particles remaining substantially non-agglomerated, may afford higher piezoelectricity after poling than is achievable with polyvinylidene difluoride alone.

As a further advantage, melt emulsification processes forming powder particulates comprising a piezoelectric composite may further incorporate nanoparticle emulsion stabilizers (Pickering emulsifiers) to afford additional enhancement of the powder particulates obtained therefrom. Such melt emulsification processes may incorporate nanoparticles, such as carbon black, and/or silica nanoparticles or other oxide nanoparticles, within a melt emulsification medium (carrier fluid) in which the powder particulates are formed, wherein the nanoparticles become disposed upon the outer surface of powder particulates resulting from solidification of liquefied thermoplastic polymer droplets. The coating or partial coating of nanoparticles upon the outer surface may result in a narrow size particle distribution and high sphericity for the powder particulates, which may afford good powder flow properties and ready particulate consolidation during additive manufacturing. If sufficiently small, the piezoelectric particles may serve as Pickering emulsifiers in some instances. Nanoparticle emulsion stabilizers disposed upon the outer surface of the powder particulates during synthesis thereof may differ from similar flow aids added to pre-formed powder particulates otherwise lacking nanoparticles, since such external flow aids do not become intimately associated with the outer surface of the powder particulates to limit removability therefrom.

Melt emulsification processes may afford powder particulates containing piezoelectric particles that may be advantaged for forming printed parts through additive manufacturing. In addition, to the advantages conveyed by forming piezoelectric composites in fine powder particulate form, various additional approaches may be utilized to increase the piezoelectric response obtained following poling of a printed part. The additional approaches for increasing the piezoelectric response advantageously are not believed to significantly alter the melt emulsification process for forming powder particulates. More specifically, an increased piezoelectric response may be realized by increasing compatibility between the thermoplastic polymer and the piezoelectric particles comprising the powder particulates, wherein increased compatibility may be realized by introducing covalent bonding and/or non-covalent bonding interactions between the thermoplastic polymer and the piezoelectric particles. Without being bound by any theory or mechanism, the compatibilizing interactions are believed to enhance the piezoelectric effect (piezoelectricity) by promoting load transfer from the thermoplastic polymer. The increased load transfer may further advantageously increase mechanical strength when forming a printed part from the powder particulates. Depending on the manner in which the compatibilizing interactions are introduced, compatibilization may take place before or after forming powder particulates comprising a piezoelectric composite according to the disclosure herein.

More specifically, powder particulates comprising a piezoelectric composite may include a plurality of piezoelectric particles that 1) interact non-covalently with at least a portion of a thermoplastic polymer by π-π bonding, hydrogen bonding, electrostatic interactions stronger than van der Waals interactions, or any combination thereof, 2) are covalently bonded to at least a portion of the thermoplastic polymer, 3) are reactive with at least a portion of the thermoplastic polymer to form at least one covalent bond thereto under specified conditions (e.g., conditions encountered during or after printing or during or after melt emulsification), or 4) any combination thereof. Such compatibilizing interactions may occur with all or a portion of the thermoplastic polymer.

Advantageously, a range of thermoplastic polymers having functionality capable of forming covalent bonds with piezoelectric particles are commercially available or may be readily produced by modification of a parent polymer backbone. Moreover, covalent bonding may take place through surface functional groups natively present upon the piezoelectric particles, such as surface hydroxyl groups. Alternately, piezoelectric particles may be readily functionalized with a linker moiety containing a functional group capable of interacting non-covalently or undergoing a reaction to form a covalent bond with a complementary functional group upon the thermoplastic polymer.

To improve the piezoelectric response still further, carbon nanomaterials may optionally be included within the powder particulates. The carbon nanomaterials may increase stiffness of a printed part and further facilitate load transfer from the piezoelectric particles to the thermoplastic polymer in the printed part, thereby increasing the piezoelectric response obtained therefrom. In addition, some carbon nanomaterials possess significant electrical conductivity and may increase the piezoelectric response attainable when present in combination with a given quantity of piezoelectric particles. At the very least, carbon nanomaterials that are electrically conductive may improve the efficiency of the poling process used to induce piezoelectricity in a printed part, thereby further enhancing the piezoelectric response attained therefrom. Like the piezoelectric particles, the carbon nanomaterials also optionally may be covalently bonded and/or non-covalently bonded to at least a portion of the thermoplastic polymer within the powder particulates described herein. Illustrative carbon nanomaterials that may be suitably used in the disclosure herein are specified further below. The carbon nanomaterials may likewise be dispersed in all or a portion of the thermoplastic polymer or concentrated in specific portions of the powder particulates (e.g., at the particulate surface and/or within the core of the powder particulates).

Nanoparticle emulsion stabilizers that are electrically conductive (e.g., carbon nanotubes and/or graphene) and disposed upon the outer surface of the powder particulates may likewise facilitate poling of printed objects formed from powder particulates. Advantageously, suitable nanoparticle emulsion stabilizers that are electrically conducive may be introduced independently of carbon nanomaterials or other additives blended with the thermoplastic polymer.

Terms used in the description and claims herein have their plain and ordinary meaning, except as modified by the paragraphs below.

As used herein, the term “immiscible” refers to a mixture of components that, when combined, form two or more phases that have less than 5 wt. % solubility in each other at ambient pressure and at room temperature or the melting point of the component if it is solid at room temperature. For example, polyethylene oxide having 10,000 g/mol molecular weight is a solid at room temperature and has a melting point of 65° C. Therefore, said polyethylene oxide is immiscible with a material that is liquid at room temperature if said material and said polyethylene oxide have less than 5 wt. % solubility in each other at 65° C. and at room temperature.

As used herein, the term “thermoplastic polymer” refers to a polymer material that softens and hardens reversibly on heating and cooling. Thermoplastic polymers are inclusive of thermoplastic elastomers.

As used herein, the term “nanoparticles” refers to a particulate material having a particle size ranging from about 1 nm to about 500 nm.

As used herein, the term “microparticles” refers to a particulate material having a particle size of 1 micron or above, such as about 1 micron to about 1000 microns, or about 1 micron to about 500 microns.

As used herein, the term “oxide” refers to both metal oxides and non-metal oxides. For purposes of the present disclosure, silicon is considered to be a metal.

As used herein, the term “oxide nanoparticles” refers to a particulate material having a particle size ranging from about 1 nm to about 500 nm and comprising a metal oxide or a non-metal oxide.

As used herein, the term “associated” refers to chemical bonding or physical adherence to a surface, particularly an emulsion stabilizer comprising nanoparticles. Without being limited by theory, it is believed that the associations described herein between polymers and emulsion stabilizers are primarily physical adherence via hydrogen bonding and/or other mechanisms. However, chemical bonding may be occurring to some degree in some instances. When associated with the outer surface of powder particulates, nanoparticles are not believed to be readily removable therefrom by physical means.

As used herein, the terms “admixed” or “mixed” refers to dissolution of a first substance in a second substance or dispersion of a first substance as a solid in a second substance, wherein the dispersion may be uniform or non-uniform.

As used herein, the term “D₁₀” refers to a diameter at which 10% of the sample (on a volume basis unless otherwise specified) is comprised of particles having a diameter less than said diameter value. As used herein, the term “D₅₀” refers to a diameter at which 50% of the sample (on a volume basis unless otherwise specified) is comprised of particles having a diameter less than said diameter value. D₅₀ may also be referred to as the “average particle size.” As used herein, the term “D₉₀” refers to a diameter at which 90% of the sample (on a volume basis unless otherwise specified) is comprised of particles having a diameter less than said diameter value.

As used herein, the terms “diameter span,” “size span” and “span” refer to the breadth of a particle size distribution and may be calculated by the relation (D₉₀−D₁₀)/D₅₀.

As used herein, the term “shear” refers to stirring or a similar process that induces mechanical agitation in a fluid.

As used herein, the term “embed” relative to nanoparticles and a surface of a powder particulate refers to the nanoparticle being at least partially extended into the surface such that polymer defining the powder particulate is in contact with the nanoparticle to a greater degree than would occur if the nanoparticle were simply laid on the surface of the powder particulate, thereby contacting the surface tangentially.

As used herein, the term “piezoelectric particles” refers to a particulate material that exhibits piezoelectricity, typically after poling.

As used herein, the term “core” refers to any portion of a powder particulate that is below a surface layer of the powder particulate. When a substance is located within the core of a powder particulate, the substance is located within the thermoplastic polymer defining the powder particulate.

As used herein, the viscosity of carrier fluids refer to the kinematic viscosity at 25° C., unless otherwise specified, and are measured per ASTM D445-19, unless otherwise specified.

The melting point of a thermoplastic polymer, unless otherwise specified, is determined by ASTM E794-06(2018) with 10° C./min ramping and cooling rates.

The softening temperature or softening point of a thermoplastic polymer, unless otherwise specified, is determined by ASTM D6090-17. The softening temperature can be measured by using a cup and ball apparatus available from Mettler-Toledo using a 0.50 gram sample with a heating rate of 1° C./min.

Particulate compositions of the present disclosure may comprise a plurality of powder particulates. The powder particulates may comprise a thermoplastic polymer and a plurality of piezoelectric particles, wherein the piezoelectric particles are located (i) in the thermoplastic polymer at an outer surface of the powder particulates, (ii) in the thermoplastic polymer within a core of the powder particulates, or (iii) combinations thereof. The powder particulates may be suitable for use in additive manufacturing processes, particularly additive manufacturing processes employing selective laser sintering or similar processes to promote particulate consolidation. Powder particulates suitable for additive manufacturing may exhibit good flow properties as a solid for dispensation in a powder bed using a print head or similar device. External flow aids mixed with the powder particulates and modifications upon the powder particulates may facilitate the dispensation process. Suitable powder particulates may also exhibit melting and crystallization temperatures compatible with a specified consolidation technique in a given additive manufacturing process.

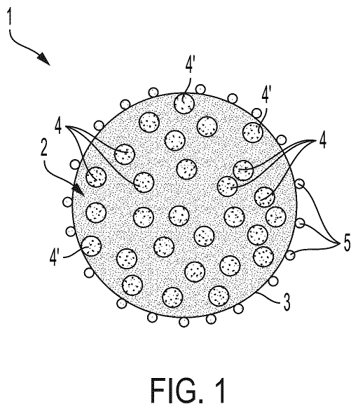

FIG. 1 is a cross-sectional diagram of an illustrative powder particulate of the present disclosure. As shown in FIG. 1, powder particulate 1 includes a polymer matrix defining core 2 and outer surface 3, with a plurality of piezoelectric particles 4 and 4′ located within the polymer matrix. Piezoelectric particles 4 and 4′ may be uniformly or non-uniformly distributed in the polymer matrix. Further, piezoelectric particles 4 and 4′ may be wholly localized within core 2 or extend from core 2 such that there is at least some piezoelectric material exposed at outer surface 3. For example, in powder particulate 1, piezoelectric particles 4 are localized within core 2, whereas piezoelectric particles 4′ may extend to outer surface 3 while still being distributed within the polymer matrix.

As further shown in FIG. 1, a plurality of nanoparticles 5 may reside upon outer surface 3 of powder particulate 1, as discussed hereinafter. Nanoparticles 5 may be associated with outer surface 3 by being introduced thereon during synthesis of powder particulate 1. Nanoparticles 5 may be differentiated in this respect from external flow aids added to powder particulate 1 following synthesis thereof.

As referenced above, some powder particulates of the present disclosure may further comprise a plurality of nanoparticles disposed upon an outer surface of the powder particulates. Optionally, at least some nanoparticles may be admixed with the thermoplastic polymer, such that a first portion of the nanoparticles is located within the core of the powder particulates and a second portion of the nanoparticles is disposed upon the outer surface of the powder particulates. The nanoparticles disposed upon the outer surface of the powder particulates may be at least partially embedded in the outer surface and associated therewith. When present, nanoparticles disposed upon the outer surface of the powder particulates may promote ready dispensation during additive manufacturing. The nanoparticles may serve as an emulsion stabilizer (Pickering emulsifier) during melt emulsification as well as provide further advantages when forming a printed part with the powder particulates.

When present, the plurality of nanoparticles may comprise a plurality of oxide nanoparticles. Oxide nanoparticles suitable for use in the present disclosure may include, for example, silica nanoparticles, titania nanoparticles, zirconia nanoparticles, alumina nanoparticles, iron oxide nanoparticles, copper oxide nanoparticles, tin oxide nanoparticles, boron oxide nanoparticles, cerium oxide nanoparticles, thallium oxide nanoparticles, tungsten oxide nanoparticles, hydroxyapatite, the like, or any combination thereof. Mixed oxides such as aluminosilicates, borosilicates, and aluminoborosilicates, for example, are also encompassed by the term “oxide.” Clays may be a suitable source of oxide nanoparticles in some instances. Nanoparticles comprising a piezoelectric material may also be used in this regard, such as lead zirconate titanate, barium titanate, potassium sodium niobate, the like, and other piezoelectric materials specified herein. The oxide nanoparticles may be hydrophilic or hydrophobic in nature, which may be native to the nanoparticles or result from surface treatment of the nanoparticles. For example, silica nanoparticles having a hydrophobic surface treatment, such as dimethylsilyl, trimethylsilyl, or the like, may be formed through reacting hydrophilic surface hydroxyl groups with an appropriate functionalizing agent. Hydrophobically functionalized oxide nanoparticles may be desirable in the present disclosure, although unfunctionalized oxide nanoparticles or hydrophilically modified oxide nanoparticles may also be suitable for use as well.

Silica nanoparticles, such as fumed silica nanoparticles with a hydrophobic functionalization thereon, may be especially suitable for use in the disclosure herein, since a variety of functionalized silicas are available, with the type of hydrophobic functionalization and the particle size being varied. Silazane and silane hydrophobic functionalizations are facile hydrophobic functionalizations that may be used in the present disclosure. As such, the plurality of oxide nanoparticles used in the disclosure herein may comprise or consist essentially of silica nanoparticles, particularly silica nanoparticles that are hydrophobically functionalized. Silica nanoparticles may be used in combination with another type of oxide nanoparticle or non-oxide nanoparticle, wherein the other type of oxide or non-oxide nanoparticle may convey properties to the powder particulates, or an object formed therefrom, that are not attained when using silica nanoparticles alone.

Carbon black is another type of nanoparticle that may be present upon powder particulates in the disclosure herein. Various grades of carbon black will be familiar to one having ordinary skill in the art, any of which may be used in the disclosure herein. Carbon black, silica, and other types of oxide nanoparticles may be present in combination with one another in some instances.

Polymer nanoparticles are another type of nanoparticle that may be present upon powder particulates in the disclosure herein. Suitable polymer nanoparticles may include one or more polymers that are thermosetting and/or crosslinked, such that they do not melt when processed by melt emulsification or a similar particulate formation technique according to the disclosure herein. Nanoparticles comprising high molecular weight thermoplastic polymers having high melting or decomposition points may similarly represent suitable polymers for polymer nanoparticles in the disclosure herein.

Carbon nanotubes, graphene, or any combination thereof may also comprise all or part of the nanoparticles associated with the surface of the powder particulates described herein. Carbon nanotubes, graphene or other types of carbon nanomaterials also may be admixed within the core of the individual powder particulates as well, as discussed below.

The loading and particle size of silica nanoparticles, similar oxide nanoparticles, or polymer nanoparticles upon the powder particulates may vary over a wide range in the disclosure herein. The loading of the nanoparticles may be determined by the nanoparticle concentration in a carrier fluid used to promote formation of the powder particulates, as described further below. In non-limiting examples, the concentration of nanoparticles in the carrier fluid may range from about 0.01 wt. % to about 10 wt. %, or about 0.05 wt. % to about 10 wt. %, or about 0.05 wt. % to about 5 wt. %, or about 0.1 wt. % to about 2 wt. %, or about 0.25 wt. % to about 1.5 wt. %, or about 0.2 wt. % to about 1.0 wt. %, or about 0.25 wt. % to about 1 wt. %, or about 0.25 wt. % to about 0.5 wt. % with respect to the weight of the thermoplastic polymer. Similar weight percentages of nanoparticles may be present within the powder particulates following formation thereof. The particle size of the nanoparticles may range from about 1 nm to about 100 nm, although particles sizes up to about 500 nm may also be acceptable. In non-limiting examples, the particle size of the nanoparticles may range from about 5 nm to about 75 nm, or about 5 nm to about 50 nm, or about 5 nm to about 10 nm, or about 10 nm to about 20 nm, or about 20 nm to about 30 nm, or about 30 nm to about 40 nm, or about 40 nm to about 50 nm, or about 50 nm to about 60 nm. The nanoparticles, particularly silica nanoparticles and similar oxide nanoparticles, may have a BET surface area of about 10 m²/g to about 500 m²/g, or about 10 m²/g to about 150 m²/g, or about 25 m²/g to about 100 m²/g, or about 100 m²/g to about 250 m²/g, or about 250 m²/g to about 500 m²/g.

Particular silica nanoparticles suitable for use in the disclosure herein may be hydrophobically functionalized. Such hydrophobic functionalization may make the silica nanoparticles less compatible with water than are unfunctionalized silica nanoparticles. In addition, the hydrophobic functionalization may improve dispersion of the silica nanoparticles in the carrier fluid, which may be highly hydrophobic. The hydrophobic functionalization may be non-covalently or covalently attached to a surface of the silica nanoparticles. Covalent attachment may take place, for example, through functionalization of surface hydroxyl groups on the surface of the silica nanoparticles. In a non-limiting example, silica nanoparticles may be treated with hexamethyldisilazane to afford covalent functionalization of a hydrophobic modification. Commercially available hydrophobically functionalized silica nanoparticles include, for example, AEROSIL RX50 (Evonik, average particle size=40 nm) and AEROSIL R812S (Evonik, average particle size=7 nm).

The powder particulates of the present disclosure may afford printed parts having a high degree of piezoelectricity, after poling, in combination with good mechanical properties. The degree of piezoelectricity achievable from the powder particulates may be determined by d₃₃ values of printed thin films that are then poled. Single-layer thin films having a d₃₃ value, after poling, of about 1 pC/N or more at a film thickness of about 200-500 microns, preferably about 200 microns, as measured using an APC International Wide-Range d₃₃ meter or similar device, may be formed from the powder particulates. Thin film thicknesses are measured using standard techniques separately from the d₃₃ measurements. In more particular examples, the powder particulates may be capable of forming single-layer thin films having a d₃₃ value, after poling, of about 1 pC/N to about 400 pC/N, or about 2 pC/N to about 200 pC/N, or about 3 pC/N to about 100 pC/N, or about 1 pC/N to about 75 pC/N, or about 5 pC/N to about 50 pC/N, or about 1 pC/N to about 10 pC/N, or about 2 pC/N to about 8 pC/N, or about 3 pC/N to about 10 pC/N, or about 1 pC/N to about 5 pC/N, or about 4 pC/N to about 7 pC/N under these conditions (e.g., at a film thickness of about 200 microns). Single-layer film thicknesses that may be printable with the powder particulates may range from about 10 μm to about 500 m in thickness or about 25 μm to about 400 μm in thickness. Suitable poling conditions are described further herein.

The loading of piezoelectric particles within the powder particulates may be selected to afford a desired extent of piezoelectricity. The thermoplastic polymer or the piezoelectric particles may constitute a majority component of the powder particulates. In some examples, the piezoelectric particles may comprise at least about 1 vol. %, or at least about 5 vol. %, or at least about 10 vol. %, or at least at least about 20 vol. %, or at least about 25 vol. %, or at least about 60 vol. %, or at least about 70 vol. %, or at least about 80 vol. %, or at least about 85 vol. %, or at least about 90 vol. %, or at least about 95 vol. % of the powder particulates. In more particular examples, the piezoelectric particles may comprise about 1 vol. % to about 10 vol. %, or about 2 vol. % to about 5 vol. %, or about 5 vol. % to about 15 vol. %, or about 10 vol. % to about 20 vol. %, or about 20 vol. % to about 30 vol. %, or about 25 vol. % to about 75 vol. %, or about 40 vol. % to about 60 vol. %, or about 50 vol. % to about 70 vol. % of the powder particulates. In some or other specific embodiments, the piezoelectric particles may comprise about 5 vol. % to about 85 vol. % of the powder particulates. A maximum volume percentage of the piezoelectric particles may be chosen such that the powder particulates are still formed during melt emulsification, such that the powder particulates comprise a composite of the thermoplastic polymer and the piezoelectric particles. In addition, the amount of piezoelectric particles may be selected such that the powder particulates remain printable during a chosen additive manufacturing process. As indicated above, the piezoelectric particles may be located in the thermoplastic polymer and present at the surface of the powder particulates, located within the thermoplastic polymer in a core of the powder particulates under conditions at which the piezoelectric particles remain substantially dispersed as individuals without becoming significantly agglomerated with each other, or any combination thereof. The vol. % loading of piezoelectric particles may be selected to afford distribution of the piezoelectric particles in a desired location within the powder particulates. Surface localization of the piezoelectric particles and/or the extent of agglomeration of the piezoelectric particles may also impact the extent of piezoelectricity that is obtained.

Piezoelectric particles that may be present in the powder particulates are not believed to be especially limited, provided that the piezoelectric particles may be adequately blended with the thermoplastic polymer. The piezoelectric particles may be blended with the thermoplastic polymer substantially as individual particles (non-agglomerated) and need not necessarily be covalently bonded to the thermoplastic polymer to achieve a satisfactory extent of blending. However, such covalent bonding may afford other advantages, as described herein. The amount of piezoelectric particles melt blended with the thermoplastic polymer may be selected such that the piezoelectric particles are no more agglomerated than before they were introduced to the thermoplastic polymer. Illustrative examples of piezoelectric materials that may be present in powder particulates of the present disclosure include, but are not limited to, ceramics and naturally occurring piezoelectric materials. Suitable crystalline ceramics exhibiting piezoelectric properties may include, but are not limited to, lead zirconate titanate (PZT), potassium niobate, sodium tungstate, Ba₂NaNNb₅O₅, and Pb₂KNb₅O₁₅. Other ceramics exhibiting piezoelectric properties may include, but are not limited to, sodium potassium niobate, bismuth ferrite, sodium niobate, barium titanate, bismuth titanate, and sodium bismuth titanate. Particularly suitable examples of piezoelectric particles for use in the disclosure herein may include those containing, for instance, lead zirconate titanate, doped lead zirconate titanate, barium titanate, lead titanate, strontium titanate, lead magnesium niobate, lead magnesium niobate-lead titanate, sodium potassium niobate, calcium copper titanate, bismuth sodium titanate, gallium phosphate, quartz, tourmaline and any combination thereof. Suitable dopants for lead zironate titanate may include, but are not limited to, Ni, Bi, La, and Nd.

Other suitable piezoelectric particles may include naturally occurring piezoelectric materials such as, for example, quartz crystals, cane sugar, Rochelle salt, topaz, bone, or any combination thereof.

The piezoelectric particles employed in the disclosure herein may have an average particle size in a micrometer (microparticles) or nanometer (nanoparticles) size range. In more particular examples, suitable piezoelectric particles may have a diameter of about 25 microns or less, or about 10 microns or less, such as about 1 micron to about 10 microns, or about 2 microns to about 8 microns. Smaller piezoelectric particles, such as those have an average particle size under 100 nm, or an average particle size of about 10 nm to about 500 nm, or an average particle size of about 100 nm to about 500 nm, or an average particle size of about 500 nm to about 1 micron may also be utilized in the disclosure herein.

Agglomeration refers to an assembly comprising a plurality of particulates that are loosely held together through physical bonding forces. Agglomerates may be broken apart through input of energy, such as through applying ultrasonic energy (e.g., by probe sonication), to break the physical bonds. Individual piezoelectric particles that have been produced through de-agglomeration may remain de-agglomerated once blending with a thermoplastic polymer has taken place. That is, defined agglomerates are not believed to re-form when forming a composite by melt blending and/or when producing powder particulates therefrom. It is to be appreciated that two or more piezoelectric particles may be in contact with one another in a given powder particulate or a composite precursor to powder particulates, but the extent of interaction is less than that occurring in an agglomerate. In non-limiting examples, agglomerates of piezoelectric particles may have a size ranging from about 100 microns to about 200 microns, and individual piezoelectric particles obtained after de-agglomeration may be in a size range of about 1 micron to about 5 microns, or about 1 micron to about 10 microns, or about 1 micron to about 2 microns, or any other piezoelectric particle size range disclosed above. Particles under 1 micron in size (nanoparticles) may also be obtained in some instances. The de-agglomerated piezoelectric particle sizes may be maintained following formation of powder particulates according to the present disclosure. Other suitable techniques for de-agglomerating piezoelectric particles may include bath sonication, homogenization, ball milling, or the like.

In some embodiments, the piezoelectric particles may undergo a compatibilizing interaction with the thermoplastic polymer within the powder particulates. The piezoelectric particles may be compatibilized through a reaction of native functional groups present upon the piezoelectric particles or a non-covalent interaction of the native functional groups, or the piezoelectric particles may be further functionalized with a linker moiety attaching a functional group that may achieve compatibilization with a complementary functional group upon the thermoplastic polymer, either covalently or non-covalently. Suitable examples of functional groups of both types upon the piezoelectric particles and located within the thermoplastic polymer are discussed in further detail below. In one example, surface hydroxyl groups upon the piezoelectric particles may be functionalized with a silane moiety having at least one functional group that is reactive or interacts non-covalently with a complementary functional group located within the thermoplastic polymer. Other functionalization strategies for reacting native functional groups upon the surface of piezoelectric particles to introduce a suitable functional group for promoting a compatibilizing interaction according to the disclosure herein may be envisioned by one having ordinary skill in the art. Linker moieties attached to the surface of the piezoelectric particles, such as through the attachment chemistries discussed above, may also be utilized to introduce functional groups capable of experiencing a compatibilizing interaction with a complementary functional group upon the thermoplastic polymer.

Illustrative types of covalent bonds that may be formed between the piezoelectric particles and the thermoplastic polymer may include, but are not limited to, ethers, esters, amides, imides, carbon-carbon bonds, metal-ligand bonds, and the like. Other suitable examples will be familiar to one having ordinary skill in the art. Surface functional groups upon the piezoelectric particles and/or functional groups appended to the surface of the piezoelectric particles via a linker moiety may be utilized for forming the covalent bonds.

A functional group upon the piezoelectric particles may be suitable for promoting covalent bond formation. In non-limiting examples, the functional group upon the piezoelectric particles may comprise one of 1) a nucleophile or 2) an electrophile, and a complementary functional group upon the thermoplastic polymer may comprise the other of 1) a nucleophile or 2) an electrophile. Suitable nucleophiles that may be present upon the piezoelectric particles (either upon the particle surface or bonded through a linker moiety) or upon the thermoplastic polymer may include, for example, alcohols, thiols, amines, carboxylates, and the like. Suitable electrophiles that may be present upon the piezoelectric particles (either upon the particle surface or bonded through a linker moiety) or upon the thermoplastic polymer may include, for example, an alkyl halide, a benzylic halide, an epoxide, an acyl group (e.g., an aldehyde, a ketone, a carboxylic acid, a carboxylic acid anhydride (including cyclic anhydrides), a carboxylic acid chloride, and the like), an α,β-unsaturated carbonyl, a cyanate, an isocyanate, a thiocyanate, an isothiocyanate, and the like.

In some examples, the piezoelectric particles may include a nucleophile and the thermoplastic polymer may comprise an electrophile that is reactive with the nucleophile upon the piezoelectric particles. In more specific examples, the thermoplastic polymer may comprise a plurality of reactive groups (e.g., upon a side chain or as an end group) comprising a carboxylic acid or a carboxylic acid derivative that is reactive with a nucleophile located upon the piezoelectric particles. Still more specifically, the thermoplastic polymer may comprise a plurality of reactive groups comprising an anhydride, a carboxylic acid, or any combination thereof, and the piezoelectric particles may be covalently bonded to the thermoplastic polymer as a reaction product of at least a portion of the plurality of reactive groups. Suitable nucleophiles that may react with an anhydride group or a carboxylic acid group may include, for example, an amine (e.g., a primary or secondary amine) or an alcohol group. In the case of an amine being present upon the piezoelectric particles, the reaction product may comprise an amide. A cyclic anhydride upon the thermoplastic polymer may form a cyclic imide upon reacting with an amine nucleophile upon the piezoelectric particles. In the case of an alcohol being present upon the piezoelectric particles, the reaction product may comprise an ester when reacted with a carboxylic acid or carboxylic acid derivative upon the thermoplastic polymer.

It is to be recognized that all of the reactive groups upon the thermoplastic polymer (or the piezoelectric particles) need not necessarily undergo a reaction to form a reaction product in the disclosure herein. Accordingly, a thermoplastic polymer that is covalently bonded to (or reactive with) a piezoelectric particle may further include a plurality of unreacted reactive groups that have not reacted with piezoelectric particles. The loading of piezoelectric particles in the composites may dictate the extent of the reaction that occurs with the thermoplastic polymer.

Optionally, the piezoelectric particles may be covalently bonded with each other and/or interact non-covalently with each other, in addition to the piezoelectric particles undergoing a compatibilizing interaction with the thermoplastic polymer. Suitable non-covalent interactions between the piezoelectric particles may include π-π bonding, hydrogen bonding, electrostatic interactions stronger than van der Waals interactions, or any combination thereof. Again, it is to be understood that all reactive functional groups need not necessarily undergo a reaction when covalently bonding piezoelectric particles to each other.

Non-covalent interactions resulting from π-π bonding may arise when two aromatic groups interact interfacially with each other. Thus, to produce a π-π non-covalent interaction between the thermoplastic polymer and the piezoelectric particles (or between the piezoelectric particles), at least one aromatic group may be present upon the thermoplastic polymer and the piezoelectric particles. Non-covalent interactions by π-π bonding can occur when the delocalized π-electron clouds of aromatic ring systems interact interfacially with one another, preferably extended aromatic ring systems containing two or more fused aromatic rings. The aromatic group upon piezoelectric particles undergoing π-π bonding may be directly attached to a surface of the particles or be appended by a linker moiety covalently attached to a surface of the particles. Linker moieties suitable for attaching an aromatic group to piezoelectric particles having hydroxyl groups upon a surface thereof may include, for example, silane-terminated or thiol-terminated linker moieties. Illustrative silane functionalities that can form a covalent bond with surface hydroxyl groups of piezoelectric particles may include, for example, alkoxysilanes, dialkoxysilanes, trialkoxysilanes, alkyldialkoxysilanes, dialkylalkoxysilanes, aryloxysilanes, diaryloxysilanes, triaryloxysilanes, silanols, disilanols, trisilanols, and any combination thereof. Aromatic groups suitable for promoting non-covalent interactions between a thermoplastic polymer and piezoelectric particles may include, for example, phenyl, naphthalenyl, anthracenyl, phenanthrenyl, pyrenyl, benz(a)anthracenyl, tetracenyl, benzo[a]pyrenyl, benzo[e]pyrenyl, benzo(g,h,i)perylenyl, chrysenyl, and dibenz(a,h)anthracenyl. If not already present in a given type of thermoplastic polymer, a co-monomer containing an aromatic group may be copolymerized with one or more non-aromatic monomers or grafted onto an existing polymer chain (or a functional group added to an existing polymer chain) to produce a thermoplastic polymer suitable for promoting π-π bonding. Other types of groups that may bond covalently to the surface of piezoelectric particles for introducing various functionalities thereon, such as an aromatic group, include, for example, phosphines, phosphine oxides, phosphonic acids, phosphonyl esters, carboxylic acids, alcohols, and amines.

Non-covalent interactions resulting from hydrogen bonding may arise when a hydrogen bond donor and a hydrogen bond acceptor interact with each other. The hydrogen bond donor and the hydrogen bond acceptor may be located upon any combination of the piezoelectric particles and the thermoplastic polymer in the disclosure herein. Hydrogen bond donors may include, for example, hydroxyl groups, amine groups, carboxylic acid groups, and the like. Hydrogen bond acceptors may include any oxygen atom or oxygen-containing functional group, any nitrogen atom or nitrogen-containing functional group, or a fluorine atom. If not already present upon the piezoelectric particles or the thermoplastic polymer, suitable hydrogen bond donors or hydrogen bond acceptors may be introduced by one having ordinary skill in the art. Optionally, hydrogen bond donors or hydrogen bond acceptors may be introduced onto piezoelectric particles through a linker moiety using similar attachment chemistries to those discussed above.

Non-covalent interactions resulting from electrostatic interactions may arise when any combination of the piezoelectric particles and the thermoplastic polymer have opposite charges interacting with each other (charge pairing or charge-charge interactions), including induced charge interactions in a dipole. Positively charged groups that may be present upon any of the piezoelectric particles or the thermoplastic polymer may include, for example, protonated amines and quaternary ammonium groups. Negatively charged groups that may be present upon any of the piezoelectric particles or the thermoplastic polymer may include, for example, carboxylates, sulfates, sulfonates, and the like. Like other types of non-covalent interactions, suitable groups capable of charge pairing may be introduced upon piezoelectric particles or a thermoplastic polymer by one having ordinary skill in the art, including through attachment of a linker moiety to the piezoelectric particles. Other types of suitable electrostatic interactions may include, for example, charge-dipole, dipole-dipole, induced dipole-dipole, charge-induced dipole, and the like.

Examples of thermoplastic polymers suitable for use in the disclosure herein include, but are not limited to, polyamides (e.g., Nylon-6, Nylon-12, and the like), polyurethanes, polyethylenes, polypropylenes, polyacetals, polycarbonates, polyethylene terephthalates, polybutylene terephthalates, polystyrenes, polyvinyl chlorides, polytetrafluoroethenes (polytetrafluoroethylenes, PTFE), polyesters (e.g., polylactic acid), polyethers, polyether sulfones, polyetherether ketones, polyether aryl ketones, polyacrylates, polymethacrylates, polyimides, acrylonitrile butadiene styrene (ABS), polyphenylene sulfides, vinyl polymers, polyarylene ethers (e.g., polyphenylene ethers, i.e., polyphenylene oxides), polyarylene sulfides, polysulfones, polyether ketones, polyaryl ether ketones (PAEK), polyamide-imides, polyetherimides, polyetheresters, copolymers comprising a polyether block and a polyamide block (PEBA or polyether block amide), grafted or ungrafted thermoplastic polyolefins, functionalized or nonfunctionalized ethylene/vinyl monomer polymer, functionalized or nonfunctionalized ethylene/alkyl (meth)acrylates, functionalized or nonfunctionalized (meth)acrylic acid polymers, functionalized or nonfunctionalized ethylene/vinyl monomer/alkyl (meth)acrylate terpolymers, ethylene/vinyl monomer/carbonyl terpolymers, ethylene/alkyl (meth)acrylate/carbonyl terpolymers, methylmethacrylate-butadiene-styrene (MBS)-type core-shell polymers, polystyrene-block-polybutadiene-block-poly(methyl methacrylate) (SBM) block terpolymers, chlorinated or chlorosulphonated polyethylenes, polyvinylidene fluoride, polyvinylidene difluoride (PVDF), PVDF-co-hexafluoropropylene (PVDF-co-HFP), polycaprolactone (PCL), phenolic resins, poly(ethylene/vinyl acetate)s, polybutadienes, polyisoprenes, styrenic block copolymers, styrene-butadiene-styrene (SBS) block copolymer, styrene-ethylene-butadiene-styrene (SEBS) block copolymer, styrene-isoprene-styrene (SIS) block copolymer, polyacrylonitriles, silicones, and the like, and any combination thereof. Copolymers comprising one or more of the foregoing may also be used in the present disclosure.

Particularly suitable examples of thermoplastic polymers for use in the disclosure herein may include polyamides, such as Nylon 6 or Nylon 12; acrylonitrile butadiene styrene; polylactic acid; polyurethanes; poly(arylene ether)s; polyaryletherketones; polycarbonates; polyimides; polyphenylene ethers, polyphenylene sulfides; poly(arylene sulfone)s; polyesters, such as polyethylene terephthalate, polybutylene terephthalate, polyethylene terephthalate glycol, polyethylene naphthalate, or the like; and any combination thereof.

More specific examples of suitable polyamides include, but are not limited to, polycaproamide (Nylon 6, polyamide 6, or PA6), poly(hexamethylene succinamide) (Nylon 46, polyamide 46, or PA46), polyhexamethylene adipamide (Nylon 66, polyamide 66, or PA66), polypentamethylene adipamide (Nylon 56, polyamide 56, or PA56), polyhexamethylene sebacamide (Nylon 610, polyamide 610, or PA610), polyundecaamide (Nylon 11, polyamide 11, or PA11), polydodecaamide (Nylon 12, polyamide 12, or PA12), and polyhexamethylene terephthalamide (Nylon 6T, polyamide 6T, or PA6T), Nylon 10.10 (polyamide 10.10 or PA10.10), Nylon 10.12 (polyamide 10.12 or PA10.12), Nylon 10.14 (polyamide 10.14 or PA10.14), Nylon 10.18 (polyamide 10.18 or PA10.18), Nylon 6.10 (polyamide 6.10 or PA6.10), Nylon 6.18 (polyamide 6.18 or PA6.18), nylon 6.12 (polyamide 6.12 or PA6.12), Nylon 6.14 (polyamide 6.14 or PA6.14), semi-aromatic polyamide, and the like, and any combination thereof. Copolyamides may also be used. Examples of suitable copolyamides include, but are not limited to, PA 11/10.10, PA 6/11, PA 6.6/6, PA 11/12, PA 10.10/10.12, PA 10.10/10.14, PA 11/10.36, PA 11/6.36, PA 10.10/10.36, and the like, and any combination thereof. Polyesteramides, polyetheresteramides, polycarbonate-esteramides, and polyether-block-amides, which may be elastomeric, may also be used.

Examples of suitable polyurethanes include, but are not limited to, polyether polyurethanes, polyester polyurethanes, mixed polyether and polyester polyurethanes, the like, and any combination thereof. Examples of suitable polyurethanes include, but are not limited to, poly[4,4′-methylenebis(phenylisocyanate)-alt-1,4-butanediol/di(propylene glycol)/polycaprolactone], ELASTOLLAN® 1190A (a polyether polyurethane elastomer, available from BASF), ELASTOLLAN® 1190A10 (a polyether polyurethane elastomer, available from BASF), and the like, and any combination thereof.

Suitable thermoplastic polymers may be elastomeric or non-elastomeric. Some of the foregoing examples of thermoplastic polymers may be elastomeric or non-elastomeric depending on the specific composition of the polymer. For example, polyethylene that is a copolymer of ethylene and propylene may be elastomeric or not depending on the amount of propylene present in the polymer.

Elastomeric thermoplastic polymers generally fall within one of six classes: styrenic block copolymers, thermoplastic polyolefin elastomers, thermoplastic vulcanizates (also referred to as elastomeric alloys), thermoplastic polyurethanes, thermoplastic copolyesters, and thermoplastic polyamides (typically block copolymers comprising polyamide), any of which may be used in the disclosure herein. Examples of elastomeric thermoplastic polymers can be found in Handbook of Thermoplastic Elastomers, 2nd ed., B. M. Walker and C. P. Rader, eds., Van Nostrand Reinhold, New York, 1988. Examples of elastomeric thermoplastic polymers include, but are not limited to, elastomeric polyamides, polyurethanes, copolymers comprising a polyether block and a polyamide block (PEBA or polyether block amide), methyl methacrylate-butadiene-styrene (MBS)-type core-shell polymers, polystyrene-block-polybutadiene-block-poly(methyl methacrylate) (SBM) block terpolymers, polybutadienes, polyisoprenes, styrenic block copolymers, and polyacrylonitriles), silicones, and the like. Elastomeric styrenic block copolymers may include at least one block selected from the group of: isoprene, isobutylene, butylene, ethylene/butylene, ethylene-propylene, and ethylene-ethylene/propylene. More specific elastomeric styrenic block copolymer examples include, but are not limited to, poly(styrene-ethylene/butylene), poly(styrene-ethylene/butylene-styrene), poly(styrene-ethylene/propylene), styrene-ethylene/propylene-styrene), poly(styrene-ethylene/propylene-styrene-ethylene-propylene), poly(styrene-butadiene-styrene), poly(styrene-butylene-butadiene-styrene), and the like, and any combination thereof.

In non-limiting examples, powder particulates of the disclosure herein may be formed through melt emulsification. Such methods for producing powder particulates may comprise: providing a composite comprising a thermoplastic polymer and a plurality of piezoelectric particles distributed in the thermoplastic polymer; combining the composite (e.g., in pellet, powder, or shredded form) in a carrier fluid at a heating temperature at or above a melting point or softening temperature of the thermoplastic polymer, wherein the thermoplastic polymer and the carrier fluid are substantially immiscible at the heating temperature; applying sufficient shear to disperse the thermoplastic polymer as liquefied droplets containing the piezoelectric particles at the heating temperature; after liquefied droplets have formed, cooling the carrier fluid to at least a temperature at which powder particulates in a solidified state form, the powder particulates comprising the thermoplastic polymer and at least a portion of the piezoelectric particles, wherein the piezoelectric particles are located (i) in the thermoplastic polymer at an outer surface of the powder particulates, (ii) in the thermoplastic polymer within a core of the powder particulates, or (iii) combinations thereof; and separating the powder particulates from the carrier fluid. Optionally, nanoparticles may be combined with the composite in the carrier fluid, such that at least a portion of the nanoparticles are disposed upon an outer surface of each of the powder particulates. Any of the thermoplastic polymers, piezoelectric particles, and/or nanoparticles specified herein may be used.

The powder particulates may also be produced without initially forming a composite of the thermoplastic polymer and the piezoelectric particulates prior to melt emulsification. Thus, in other non-limiting examples, the thermoplastic polymer and the piezoelectric particles may be combined with the carrier fluid separately without being processed into a composite first. Such methods may comprise: combining a thermoplastic polymer and a plurality of piezoelectric particles in a carrier fluid at a heating temperature at or above a melting point or softening temperature of the thermoplastic polymer, wherein the thermoplastic polymer and the carrier fluid are substantially immiscible at the heating temperature; applying sufficient shear to disperse the thermoplastic polymer as liquefied droplets containing the piezoelectric particles at the heating temperature; after liquefied droplets have formed, cooling the carrier fluid to at least a temperature at which powder particulates in a solidified state form, the powder particulates comprising the thermoplastic polymer and at least a portion of the piezoelectric particles, wherein the nanoparticles are located (i) in the thermoplastic polymer at an outer surface of the powder particulates, (ii) in the thermoplastic polymer within a core of the powder particulates, or (iii) combinations thereof; and separating the powder particulates from the carrier fluid. Optionally, nanoparticles may be combined with the thermoplastic polymer and the piezoelectric particles in the carrier fluid, such that at least a portion of the nanoparticles are disposed upon an outer surface of each of the powder particulates. Any of the thermoplastic polymers, piezoelectric particles, and/or nanoparticles specified herein may be used.

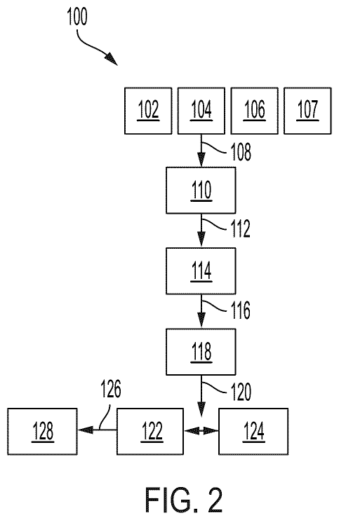

FIG. 2 is a flow chart of non-limiting example method 100 for producing powder particulates in accordance with the present disclosure, wherein powder particulate formation takes place in the presence of nanoparticles. As shown, thermoplastic polymer 102, carrier fluid 104, nanoparticles 106, and piezoelectric particles 107 are combined 108 to produce mixture 110. Optionally, thermoplastic polymer 102 and piezoelectric particles 107 may be pre-combined as a composite prior to being combined with carrier fluid 104. The composite may be formed by melt blending or melt extrusion, as specified further herein. One or more surfactants, such as one or more sulfonate surfactants, may also be present in mixture 110. Thermoplastic polymer 102, carrier fluid 104, nanoparticles 106, and metal precursor 107 may be combined 108 in any order, including previous formation of a composite of thermoplastic polymer 102 and piezoelectric particles 107, with mixing and/or heating being conducted.

Carrier fluid 104 may be heated above a melting point or softening temperature of thermoplastic polymer 102. Heating above the melting point or softening temperature of thermoplastic polymer 102 may be at any temperature below the decomposition temperature or boiling point of any of the components in the melt emulsion. In non-limiting examples, heating at a temperature about 1° C. to about 50° C., or about 1° C. to about 25° C., or about 5° C. to about 30° C., or about 20° C. to about 50° C. above the melting point or softening temperature of thermoplastic polymer 102 may be conducted. In the disclosure herein, melting points may be determined by ASTM E794-06(2018) with 10° C./min ramping and cooling rates. The softening temperature or softening point of a polymer, unless otherwise specified, is determined by ASTM D6090-17. The softening temperature can be measured by using a cup and ball apparatus available from Mettler-Toledo using a 0.50 gram sample with a heating rate of 1° C./min. Melting points or softening temperatures in the present disclosure may range from about 50° C. to about 400° C.

Mixture 110 is then processed 112 by applying sufficient shear to produce liquefied droplets of thermoplastic polymer 102 at a temperature greater than the melting point or softening temperature of thermoplastic polymer 102, thereby forming melt emulsion 114. The liquefied droplets may contain piezoelectric particles 107. Without being limited by theory, it is believed that, all other factors being the same, increasing shear may decrease the size of the liquefied droplets in carrier fluid 104. It is to be understood that at some point there may be diminishing returns on increasing shear and decreasing the droplet size in turn and/or disruptions to the droplet contents at higher shear rates. Examples of mixing apparatuses suitable for producing melt emulsion 114 include, but are not limited to, extruders (e.g., continuous extruders, batch extruders and the like), stirred reactors, blenders, reactors with inline homogenizer systems, and the like, and apparatuses derived therefrom.

In non-limiting examples, the liquefied droplets may have a size of about 1 μm to about 1,000 μm, or about 1 μm to about 500 μm, or about 1 μm to about 200 μm, or about 1 m to about 150 μm, or about 1 μm to about 130 μm, or about 1 μm to about 100 μm, or about m to about 150 μm, or about 10 μm to about 100 μm, or about 20 μm to about 80 μm, or about 20 μm to about 50 μm, or about 50 μm to about 90 μm. The resulting powder particulates formed after solidification may reside within similar size ranges. That is, the powder particulates of the present disclosure may have a size of about 1 μm to about 1,000 μm, or about 1 μm to about 500 μm, or about 1 μm to about 200 μm, or about 1 μm to about 150 μm, or about 1 μm to about 130 μm, or about 1 μm to about 100 μm, or about 1 μm to about 200 m, or about 10 μm to about 100 μm, or about 20 μm to about 80 μm, or about 20 μm to about 50 μm, or about 50 μm to about 90 μm. Particle size measurements may be made by analysis of optical images or using onboard software of a Malvern Mastersizer 3000 Aero S instrument, which uses light scattering techniques for particle size measurement.

For light scattering techniques, glass bead control samples with a diameter within the range of 15 μm to 150 μm under the tradename Quality Audit Standards QAS4002™ obtained from Malvern Analytical Ltd. may be used. Samples may be analyzed as dry powders dispersed in air using the dry powder dispersion module of the Mastersizer 3000 Aero S. Particle sizes may be derived using the instrument software from a plot of volume density as a function of size.

Melt emulsion 114 is then cooled 116 to solidify the liquefied droplets into powder particulates in a solidified state. The cooling rate may range from about 100° C./sec to about 10° C./hour or about 10° C./sec to about 10° C./hr, including any cooling rate in between. Shear may be discontinued during cooling, or may be maintained at the same rate or a different rate during cooling. Cooled mixture 118 can then be treated 120 to isolate powder particulates 122 from other components 124 (e.g., carrier fluid 104, excess nanoparticles 106, piezoelectric particles 107, and the like). Washing, filtering and/or the like may be conducted at this stage to purify powder particulates 122 further, wherein powder particulates 122 comprise thermoplastic polymer 102, at least a portion of nanoparticles 106 coating the outer surface of powder particulates 122, and at least a portion of piezoelectric particles 107 being admixed within a polymer matrix defining powder particulates 122. Depending upon non-limiting factors such as the temperature (including cooling rate), the type of thermoplastic polymer 102, and the types and sizes of nanoparticles 106, nanoparticles 106 may become at least partially embedded within the outer surface of powder particulates 122 in the course of becoming disposed thereon. Even without embedment taking place, nanoparticles 106 may remain robustly associated with powder particulates 122 to facilitate their further use. Piezoelectric particles 107 may be mixed in thermoplastic polymer 102 and located at an outer surface of powder particulates 122, located within a core of powder particulates 122, or combinations thereof

In the foregoing, thermoplastic polymer 102 and carrier fluid 104 are chosen such that these components are immiscible or substantially immiscible (<5 wt. % solubility), particularly <1 wt. % solubility, at the various processing temperatures (e.g., from room temperature to the temperature at which liquefied droplets are formed and maintained as two or more phases).

After separating powder particulates 122 from other components 124, further processing 126 of powder particulates 122 may take place. In non-limiting examples, further processing 126 may include, for example, sieving powder particulates 122 and/or blending powder particulates 122 with other substances to form processed powder particulates 128. For example, powder particulates 122 may be combined with an external flow aid in some instances. Processed powder particulates 128 may be formulated for use in a desired application, such as additive manufacturing in a non-limiting example.

Powder particulates of the present disclosure may have a bulk density of about 0.2 g/cm³ to about 10 g/cm³, or about 0.3 g/cm³ to about 8 g/cm³, or about 0.7 g/cm³ to about 7 g/cm³, or about 1 g/cm³ to about 6 g/cm³, or about 0.3 g/cm³ to about 3.5 g/cm³, or about 0.3 g/cm³ to about 4 g/cm³, or about 0.3 g/cm³ to about 5 g/cm³, or about 0.3 g/cm³ to about 6 g/cm³, or about 0.4 g/cm³ to about 0.7 g/cm³, or about 0.5 g/cm³ to about 0.6 g/cm³, or about 0.5 g/cm³ to about 0.8 g/cm³, or about 1.0 g/cm³ to about 1.2 g/cm³, or about 1.2 g/cm³ to about 1.5 g/cm³, or about 1.5 g/cm³ to about 1.8 g/cm³, or about 1.8 g/cm³ to about 2 g/cm³, or about 2 g/cm³ to about 2.5 g/cm³, or about 2.5 g/cm³ to about 3 g/cm³. Still other powder particulates may have a bulk density of about 3 g/cm³ to about 4 g/cm³, or about 4 g/cm³ to about 5 g/cm³, or about 5 g/cm³ to about 6 g/cm³, or about 6 g/cm³ to about 7 g/cm³, or about 6 g/cm³ to about 8 g/cm³, or about 8 g/cm³ to about 10 g/cm³.

Shear sufficient to form liquefied droplets may be applied through stirring the carrier fluid in the present disclosure. In non-limiting examples, the stirring rate may range from about 50 rotations per minute (RPM) to about 1500 RPM, or about 250 RPM to about 1000 RPM, or about 225 RPM to about 500 RPM. The stirring rate while melting the thermoplastic polymer may be the same as or different than the stirring rate used once liquefied droplets have formed. The liquefied droplets may be stirred over a stirring time of about 30 seconds to about 18 hours or longer, or about 1 minute to about 180 minutes, or about 1 minute to about 60 minutes, or about 5 minutes to about 6 minutes, or about 5 minutes to about 30 minutes, or about 10 minutes to about 30 minutes, or about 30 minutes to about 60 minutes.

Loading (concentration) of the thermoplastic polymer in the carrier fluid may vary over a wide range. In non-limiting examples, the loading of the thermoplastic polymer in the carrier fluid may range from about 1 wt. % to about 99 wt. % relative to the weight of the carrier fluid. In more particular examples, the loading of the thermoplastic polymer may range from about 5 wt. % to about 75 wt. %, or about 10 wt. % to about 60 wt. %, or about 20 wt. % to about 50 wt. %, or about 20 wt. % to about 30 wt. %, or about 30 wt. % to about 40 wt. %, or about 40 wt. % to about 50 wt. %, or about 50 wt. % to about 60 wt. %. The thermoplastic polymer may be present in an amount ranging from about 5 wt. % to about 60 wt. %, or about 5 wt. % to about 25 wt. %, or about 10 wt. % to about 30 wt. %, or about 20 wt. % to about 45 wt. %, or about 25 wt. % to about 50 wt. %, or about 40 wt. % to about 60 wt. % relative to a combined amount of the thermoplastic polymer and the carrier fluid.

Upon forming powder particulates in the presence of nanoparticles according to the disclosure herein, at least a portion of the nanoparticles, such as silica nanoparticles or other oxide nanoparticles, may be disposed as a coating or partial coating upon the outer surface of the powder particulates. The coating may be disposed substantially uniformly upon the outer surface. As used herein with respect to a coating, the term “substantially uniform” refers to even coating thickness in surface locations covered by the nanoparticles, including the entirety of the outer surface. Coating coverage upon the powder particulates may range from about 5% to about 100%, or about 5% to about 25%, or about 20% to about 50%, or about 40% to about 70%, or about 50% to about 80%, or about 60% to about 90%, or about 70% to about 100% of the surface area of the powder particulates. Coverage may be determined by image analysis of SEM micrographs.

Carrier fluids suitable for use in the disclosure herein include those in which the thermoplastic polymer is substantially immiscible with the carrier fluid, the carrier fluid has a boiling point exceeding the melting point or softening temperature of the thermoplastic polymer, and the carrier fluid has sufficient viscosity to form liquefied droplets of substantially spherical shape once the thermoplastic polymer has undergone melting therein. Suitable carrier fluids may include, for example, silicone oil, fluorinated silicone oils, perfluorinated silicone oils, polyethylene glycols, alkyl-terminal polyethylene glycols (e.g., C1-C4 terminal alkyl groups like tetraethylene glycol dimethyl ether (TDG)), paraffins, liquid petroleumielly, vison oils, turtle oils, soya bean oils, perhydrosqualene, sweet almond oils, calophyllum oils, palm oils, parleam oils, grapeseed oils, sesame oils, maize oils, rapeseed oils, sunflower oils, cottonseed oils, apricot oils, castor oils, avocado oils, jojoba oils, olive oils, cereal germ oils, esters of lanolic acid, esters of oleic acid, esters of lauric acid, esters of stearic acid, fatty esters, higher fatty acids, fatty alcohols, polysiloxanes modified with fatty acids, polysiloxanes modified with fatty alcohols, polysiloxanes modified with polyoxy alkylenes, and the like, and any combination thereof.

Suitable carrier fluids may have a density of about 0.6 g/cm³ to about 1.5 g/cm³, and the thermoplastic polymer alone may have a density of about 0.7 g/cm³ to about 1.8 g/cm³, wherein the thermoplastic polymer has a density similar to, lower than, or higher than the density of the carrier fluid.

Particularly suitable silicone oils are polysiloxanes. Illustrative silicone oils suitable for use in the disclosure herein include, for example, polydimethylsiloxane (PDMS), methylphenylpolysiloxane, an alkyl modified polydimethylsiloxane, an alkyl modified methylphenylpolysiloxane, an amino modified polydimethylsiloxane, an amino modified methylphenylpolysiloxane, a fluorine modified polydimethylsiloxane, a fluorine modified methylphenylpolysiloxane, a polyether modified polydimethylsiloxane, a polyether modified methylphenylpolysiloxane, the like and any combination thereof.

In non-limiting examples, the carrier fluid and the thermoplastic polymer may be heated at a temperature of about 100° C. or above, or about 120° C. or above, or about 140° C. or above, or about 160° C. or above, or about 180° C. or above, or about 200° C. or above, or about 220° C. or above, or about 240° C. or above. Suitable heating temperatures may be chosen based upon the melting point or softening temperature of the thermoplastic polymer and the boiling point of the carrier fluid. The cooling rate following formation of liquefied droplets may be varied as desired. In some instances, cooling may take place with heat dissipation to the surrounding environment taking place at an innate (uncontrolled) rate once heating is discontinued. In other cases, cooling at a controlled rate (e.g., by gradually decreasing the heating temperature and/or using jacketed temperature control to increase or decrease the rate of cooling) may be employed.

Suitable carrier fluids, such as polysiloxanes, including PDMS, may have a viscosity at 25° C. of about 1,000 cSt to about 150,000 cSt, or about 1,000 cSt to about 60,000 cSt, or about 40,000 cSt to about 100,000 cSt, or about 75,000 cSt to about 150,000 cSt. The viscosity of the carrier fluid may be obtained from commercial suppliers or it may be measured, if desired, through techniques known to persons having ordinary skill in the art.

Separating the powder particulates from the carrier fluid may take place by any of a variety of known separation techniques. Any of gravity settling and filtration, decantation, centrifugation, or the like may be used to separate the powder particulates from the carrier fluid. The powder particulates may then be washed with a solvent in which the carrier fluid is soluble and the powder particulates are insoluble in the course of the separation process. In addition, a solvent in which the carrier fluid is soluble and the powder particulates are insoluble may be mixed with the carrier fluid and the powder particulates before initially separating the powder particulates from the carrier fluid.

Suitable solvents for washing the powder particulates or mixing with the carrier fluid may include, but are not limited to, aromatic hydrocarbons (e.g., toluene and/or xylene), aliphatic hydrocarbons (e.g., heptane, n-hexane, and/or n-octane), cyclic hydrocarbons (e.g., cyclopentane, cyclohexane, and/or cyclooctane), ethers (e.g. diethyl ether, tetrahydrofuran, diisopropyl ether, and/or dioxane), halogenated hydrocarbons (e.g., dichloroethane, trichloroethane, dichloromethane, chloroform and/or carbon tetrachloride), alcohols (e.g., methanol, ethanol, isopropanol, and/or n-propanol), ketones (e.g., methyl ethyl ketone and/or acetone); esters (e.g., ethyl acetate and the like), water, the like, and any combination thereof. After washing the powder particulates, any of heating, vacuum drying, air drying, or any combination thereof may be performed.

In some embodiments, at least a majority of the powder particulates obtained according to the disclosure herein may be substantially spherical in shape. More typically, about 90% or greater, or about 95% or greater, or about 99% or greater of the powder particulates produced by melt emulsification according to the present disclosure may be substantially spherical in shape. It is to be appreciated, however, that less spherical particles may be produced in some instances and remain suitable for the applications described herein unless expressly specified otherwise. In other non-limiting examples, the powder particulates of the present disclosure may have a sphericity (circularity) of about 0.9 or greater, including about 0.90 to about 1.0, or about 0.93 to about 0.99, or about 0.95 to about 0.99, or about 0.97 to about 0.99, or about 0.98 to 1.0. Sphericity (circularity) may be measured using a Sysmex FPIA-2100 Flow Particle Image Analyzer. To determine circularity, optical microscopy images are taken of the powder particulates. The perimeter (P) and area (A) of the particulates in the plane of the microscopy image is calculated (e.g., using a SYSMEX FPIA 3000 particle shape and particle size analyzer, available from Malvern Instruments). The circularity of the particulate is C_{EA}/P, where C_{EA} is the circumference of a circle having the area equivalent to the area (A) of the actual particulate.

The powder particulates of the present disclosure may have an angle of repose of about 250 to about 45°, or about 25° to about 35°, or about 30° to about 40°, or about 350 to about 45°. Angle of repose may be determined using a Hosokawa Micron Powder Characteristics Tester PT-R using ASTM D6393-14 “Standard Test Method for Bulk Solids Characterized by Carr Indices.”

Powder particulates isolated from the carrier fluid according to the disclosure above may be further processed to make the powder particulates suitable for an intended application. In one example, the powder particulates may be passed through a sieve or similar structure having an effective screening size that is greater than the average particle size of the powder particulates. For example, an illustrative screening size for processing powder particulates suitable for use in three-dimensional printing may have an effective screening size of about 150 μm. When referring to sieving, pore/screen sizes are described per U.S.A. Standard Sieve (ASTM E11-17). Other screening sizes, either larger or smaller, may be more suitable for powder particulates destined for use in other applications. Sieving may remove larger particulates that may have formed during the melt emulsification process and/or remove agglomerated particulates that may have poor flow characteristics. When employed, sieves having an effective screening size ranging from about 10 μm to about 250 μm may be used.

In addition, the powder particulates, including sieved powder particulates, may be mixed with one or more additional components such as flow aids, fillers or other substances intended to tailor the properties of the powder particulates for an intended application. Mixing of the additional components with the powder particulates may be conducted by dry blending techniques. Suitable examples of flow aids (e.g., carbon black, graphite, silica, and the like) and similar substances will be familiar to one having ordinary skill in the art. Carbon nanotubes, graphene, and the like may be present as a filler within the powder particulates to increase the piezoelectric response obtained after forming a printed object and poling.

In some embodiments, the powder particulates disclosed herein may be free of solvents, free of flow aids, and free of surfactants.

The powder particulates disclosed herein may be utilized in additive manufacturing processes, especially those employing selective laser sintering or other powder bed fusion processes to promote particulate consolidation. Printed objects formed therefrom may comprise a composite, wherein the polymer matrix within a printed object comprises the thermoplastic polymer and piezoelectric particles are located within the polymer matrix. As with the powder particulates discussed above, the piezoelectric particles within a printed object may be substantially non-agglomerated. Moreover, the piezoelectric particles may be present within the polymer matrix defining a printed object and be located at a surface of the printed object, be located wholly within the interior of the printed object, or any combination thereof.

Printed objects formed through layer-by-layer consolidation of molten polymer obtained from a polymer filament (e.g., during fused filament fabrication or a similar process) may be distinguished from those prepared by consolidation of powder particulates (e.g., during powder bed fusion processes) by the presence or absence of grain boundaries and the type thereof. There may be residual grain boundaries between incompletely fused powder particulates in printed objects formed through powder bed fusion and similar particulate consolidation processes, whereas those formed through fused filament fabrication or similar processes may be characterized by evidence of boundaries between adjacent printed lines and layers. Although possibly distinguishable on a microscopic level, printed objects formed from polymer filaments or powder particulates may be substantially indistinguishable from one another on the macroscale.

Piezoelectric properties may be obtained in the printed objects after poling. Poling involves subjecting an object to a very high electric field so that dipoles of a piezoelectric material orient themselves to align in the direction of the applied field. Suitable poling conditions will be familiar to one having ordinary skill in the art. In non-limiting examples, poling may be conducted by corona poling, electrode poling or any combination thereof. In corona poling, a piezoelectric material is subjected to a corona discharge in which charged ions are generated and collect on a surface. An electric field is generated between the charged ions on the surface and a grounded plane opposite the surface. The grounded plane may be directly adhered to an object undergoing poling or present separately as a grounded plate. In electrode poling (or contact poling), two electrodes are placed on either side of a piezoelectric material, and the material is subjected to a high electric field generated between the two electrodes. Although poling may be conducted as a separate step during formation of a printed object, poling may also be conducted in concert with an additive manufacturing process, such as when consolidating powder particulates within a powder bed. In non-limiting examples, a high voltage may be applied between a print head supplying the powder particulates and a powder bed within which the printed part is being formed through particulate consolidation.

Accordingly, additive manufacturing processes of the present disclosure may comprise: depositing in a powder bed a particulate composition comprising a plurality of powder particulates comprising a thermoplastic polymer and a plurality of piezoelectric particles, wherein the piezoelectric particles are located (i) in the thermoplastic polymer at an outer surface of the powder particulates, (ii) in the thermoplastic polymer within a core of the powder particulates, or (iii) combinations thereof, and consolidating a portion of the plurality of powder particulates in the powder bed, such as through performing selective laser sintering, to form a printed object. The additive manufacturing processes may further comprise poling at least a portion of the printed object after formation thereof. In more specific examples, nanoparticles may be present upon the powder particulates, such that the nanoparticles are also incorporated within the printed object. The nanoparticles may be present in the printed objects in the same location and/or different locations from those where the piezoelectric particles are located.

Examples of printed objects formable using the particulate compositions disclosed herein are not considered to be particularly limited and may include, but are not limited to, containers (e.g., for food, beverages, cosmetics, personal care compositions, medicine, and the like), shoe soles, toys, furniture parts, decorative home goods, plastic gears, screws, nuts, bolts, cable ties, medical items, prosthetics, orthopedic implants, production of artifacts that aid learning in education, 3-D anatomy models to aid in surgeries, robotics, biomedical devices (orthotics), home appliances, dentistry, automotive and airplane/aerospace parts, electronics, sporting goods, sensors (e.g., pressure sensors, strain sensors, and the like), valves and actuators, energy harvesting devices, and the like.

Embodiments disclosed herein include:

A. Particulate compositions comprising powder particulates. The particulate compositions comprise: a plurality of powder particulates comprising a thermoplastic polymer and a plurality of piezoelectric particles, wherein the piezoelectric particles are located (i) in the thermoplastic polymer at an outer surface of the powder particulates, (ii) within a core of the powder particulates, or (iii) combinations thereof.

B. Printed objects. The printed objects comprise: a polymer matrix formed by particulate consolidation and comprising a thermoplastic polymer; and a plurality of piezoelectric particles located in the polymer matrix.

C. Methods for forming a printed object by particulate consolidation. The methods comprise: depositing in a powder bed a particulate composition comprising a plurality of powder particulates comprising a thermoplastic polymer and a plurality of piezoelectric particles, wherein the piezoelectric particles are located (i) in the thermoplastic polymer at an outer surface of the powder particulates, (ii) within a core of the powder particulates, or (iii) combinations thereof; and consolidating a portion of the plurality of powder particulates in the powder bed to form a printed object.

D. Methods for forming powder particulates. The methods comprise: providing a composite comprising a thermoplastic polymer and a plurality of piezoelectric particles distributed in the thermoplastic polymer; combining the composite in a carrier fluid at a heating temperature at or above a melting point or softening temperature of the thermoplastic polymer; wherein the thermoplastic polymer and the carrier fluid are substantially immiscible at the heating temperature; applying sufficient shear to disperse the thermoplastic polymer as liquefied droplets containing the piezoelectric particles at the heating temperature; after liquefied droplets have formed, cooling the carrier fluid to at least a temperature at which powder particulates in a solidified state form, the powder particulates comprising the thermoplastic polymer and at least a portion of the piezoelectric particles, wherein the piezoelectric particles are located (i) in the thermoplastic polymer at an outer surface of the powder particulates, (ii) within a core of the powder particulates, or (iii) combinations thereof; and separating the powder particulates from the carrier fluid.

E. Methods for forming powder particulates. The methods comprise: combining a thermoplastic polymer and a plurality of piezoelectric particles in a carrier fluid at a heating temperature at or above a melting point or softening temperature of the thermoplastic polymer; wherein the thermoplastic polymer and the carrier fluid are substantially immiscible at the heating temperature; applying sufficient shear to disperse the thermoplastic polymer as liquefied droplets containing the piezoelectric particles at the heating temperature; after liquefied droplets have formed, cooling the carrier fluid to at least a temperature at which powder particulates in a solidified state form, the powder particulates comprising the thermoplastic polymer and at least a portion of the piezoelectric particles, wherein the piezoelectric particles are located (i) in the thermoplastic polymer at an outer surface of the powder particulates, (ii) within a core of the powder particulates, or (iii) combinations thereof; and separating the powder particulates from the carrier fluid.

Each of embodiments A, B, C, D, and E may have one or more of the following additional elements in any combination:

Element 1: wherein the particulate composition further comprises a plurality of nanoparticles disposed upon the outer surface of each of the plurality of powder particulates, the plurality of nanoparticles comprising a plurality of oxide nanoparticles, carbon black, carbon nanotubes, graphene, or any combination thereof; and/or wherein the plurality of nanoparticles comprises a plurality of oxide nanoparticles, carbon black, or any combination thereof.

Element 1A: wherein the printed object further comprises a plurality of nanoparticles located in the polymer matrix, the plurality of nanoparticles comprising a plurality of oxide nanoparticles, carbon black, carbon nanotubes, graphene, or any combination thereof; and/or wherein the plurality of nanoparticles comprises a plurality of oxide nanoparticles, carbon black, or any combination thereof.

Element 1B: wherein the plurality of powder particulates further comprise a plurality of nanoparticles disposed upon the outer surface of each of the plurality of powder particulates, the plurality of nanoparticles comprising a plurality of oxide nanoparticles, carbon black, carbon nanotubes, graphene, or any combination thereof; and/or wherein the plurality of nanoparticles comprises a plurality of oxide nanoparticles, carbon black, or any combination thereof.

Element 2: wherein the plurality of oxide nanoparticles comprises a plurality of silica nanoparticles; and/or wherein a plurality of silica nanoparticles are disposed upon the outer surface of each of the powder particulates.

Element 3: wherein the piezoelectric particles are substantially non-agglomerated.

Element 4: wherein a single-layer thin film formed from the powder particulates has a d₃₃ value, after poling, of about 1 pC/N or more at a film thickness of about 200 microns, as measured using an APC International Wide-Range d₃₃ meter.

Element 5: wherein the piezoelectric particles have an average particle size of about 10 microns or less.

Element 6: wherein the powder particulates comprise about 5 vol. % to about 70 vol. % piezoelectric particles.

Element 7: wherein the thermoplastic polymer comprises a polymer selected from the group consisting of a polyamide, a polycaprolactone, a polylactic acid, a poly(styrene-isoprene-styrene) (SIS), a poly(styrene-ethylene-butylene-styrene) (SEBS), a poly(styrene-butylene-styrene) (SBS), a high-impact polystyrene, a polystyrene, a thermoplastic polyurethane, a poly(acrylonitrile-butadiene-styrene) (ABS), a polymethylmethacrylate, a poly(vinylpyrrolidine-vinylacetate), a polyester, a polyethylene terephthalate, a polyethylene terephthalate glycol, a polyethylene naphthalate, a polycarbonate, a polyethersulfone, a polyoxymethylene, a polyether ether ketone, a polyether aryl ketone, a polyetherimide, a polyethylene, a polyethylene oxide, a polyphenylene sulfide, a polypropylene, a polystyrene, a polyvinyl chloride, a poly(tetrafluoroethylene), a poly(vinylidene fluoride), a poly(vinylidene difluoride), a poly(vinylidene difluoride-hexafluoropropylene), any copolymer thereof, and any combination thereof.

Element 8: wherein the piezoelectric particles comprise a piezoelectric material selected from the group consisting of lead zirconate titanate, doped lead zirconate titanate, barium titanate, lead titanate, lead magnesium niobate, lead magnesium niobate-lead titanate, sodium potassium niobate, calcium copper titanate, bismuth sodium titanate, gallium phosphate, quartz, tourmaline and any combination thereof.

Element 9: wherein the powder particulates range from about 1 μm to about 500 m in size.

Element 10: wherein the method further comprises poling at least a portion of the printed object.

Element 11: wherein the method further comprises combining a plurality of nanoparticles with the composite in the carrier fluid, the plurality of nanoparticles comprising a plurality of oxide nanoparticles, carbon black or any combination thereof, wherein at least a portion of the nanoparticles are disposed upon the outer surface of each of the powder particulates.

Element 12: wherein the carrier fluid comprises a silicone oil.

By way of non-limiting example, exemplary combinations applicable to A, B, C, D and E include, but are not limited to: 1, 1A or 1B, and 2; 1, 1A or 1B, and 3; 1, 1A or 1B, and 2 and 3; 1, 1A or 1B, and 2 and 4; 1, 1A or 1B, and 2 and 5; 1, 1A or 1B, and 5; 1, 1A or 1B, and 2 and 6; 1, 1A or 1B, and 6; 1, 1A or 1B, and 7; 1, 1A or 1B, and 8; 1, 1A or 1B, and 9; 3 and 4; 3 and 5; 3 and 6; 3 and 7; 3 and 8; 3 and 9; 4 and 9; 5 and 6; 5 and 7; 5 and 8; 5 and 9; 6 and 7; 6 and 9; 6 and 10; 7 and 9; 8 and 9; and 7-9.

To facilitate a better understanding of the present disclosure, the following examples of preferred or representative embodiments are given. In no way should the following examples be read to limit, or to define, the scope of the invention.

### EXAMPLES

Average particle size measurements and particle size distributions were determined by light scattering using a Malvern Mastersizer 3000 Aero S particle size analyzer. For light scattering techniques, glass bead control samples having a diameter within the range of 15 m to 150 μm under the tradename Quality Audit Standards QAS4002™ obtained from Malvern Analytical Ltd. may be used. Samples may be analyzed as dry powders dispersed in air using the dry powder dispersion module of the Mastersizer 3000 Aero S. Particle sizes may be derived using the instrument software from a plot of volume density as a function of size.

Lead zirconate titanate (PZT, APC International, Ltd.) was sonicated using a Branson digital probe sonicator for 30 minutes in water at 25% amplitude to break up particle agglomerates. The original PZT agglomerate size of approximately 100 microns afforded PZT particles in a 1-5 micron size range following sonication, with a majority of the PZT particles being in a 1-2 micron size range.

Example 1: Formation of 1:1 (wt.:wt.) Polyamide:PZT Composite. Polyamide-12 was obtained from RTP Company and processed into a 1:1 polyamide (polyamide-12):PZT composite using a 600P Haake batch mixer. The temperature was set to 230° C. for all three plates, and the rotor speed was set to approximately 200 rpm when actuated. 30 g of polyamide (PA) pellets were added to the mixer at 230° C. while idle, and the polyamide was allowed to melt (˜5 minutes). After melting occurred, the rotors were started, and PZT (30 g) was slowly fed into the mixer using a spatula. Once addition of the PZT was complete, the top of the mixer was closed off with its ram device, and mixing was continued with stirring for another 30 minutes. After 30 minutes, the rotors were stopped, and the resulting molten composite blend was discharged into an aluminum pie plate and cooled under ambient conditions. Once fully cooled and solidified, large chunks of the extrudate were crushed using an industrial press. Further reduction of the particle size was accomplished by cryo-milling the solidified extrudate with a small handheld IKA mill. The cryo-milling was conducted by immersing small portions of the solidified extrudate in liquid nitrogen for approximately one minute followed by approximately 15-20 seconds of milling.

Example 1A: Formation of 1:3 (wt.:wt.) Polyamide:PZT Composite. 1:3 polyamide:PZT composite was prepared in the same manner as the 1:1 polyamide:PZT composite of Example 1, except 39 g of polyamide-12 and 117 g PZT were used.

Example 1B: Formation of 1:3 (wt.:wt.) Polycaprolactone:PZT Composite. Polycaprolactone (PCL) was obtained from Happy Wire Dog, LLC and processed into a 1:3 polycaprolactone:PZT composite using a 600P Haake batch mixer. The temperature was originally set to 80° C. for all three plates, and the rotor speed was set to approximately 200 rpm when actuated. 30 g of polycaprolactone pellets were added to the mixer at 80° C. while idle. The temperature was then increased to −250° C., and the polycaprolactone was allowed to melt (˜5 minutes). After melting occurred, the rotors were started, and PZT (90 g) was slowly fed into the mixer using a spatula. Once addition of the PZT was complete, the top of the mixer was closed off with its ram device, and mixing was continued with stirring for another 30 minutes. After 30 minutes, the rotors were stopped, and the resulting molten composite blend was discharged into an aluminum pie plate and cooled under ambient conditions. Once fully cooled and solidified, large chunks of the extrudate were granulated using a 3devo Shred-it polymer shredder.

Example 1C: Formation of 1:1.8 (wt.:wt.) Polyvinylidene fluoride-co-hexafluoropropylene:PZT Composite. Polyvinylidine fluoride copolymer with hexafluoropropylene (PVDF-co-HFP, KYNAR FLEX 2800-20, Arkema) was processed into a 1:1.8 PVDF:PZT composite using a 600P Haake batch mixer. The temperature was originally set to 230° C. for all three plates, and the rotor speed was set to approximately 200 rpm when actuated. 56 g of PVDF was added to the mixer at 230° C. while idle, and the polymer was allowed to melt (˜5 minutes). After melting occurred, the rotors were started, and PZT (103.4 g) was slowly fed into the mixer using a spatula. The rotor speed was lowered gradually during addition of the PZT due to an increase in viscosity. Once addition of the PZT was complete, the top of the mixer was closed off with its ram device, and mixing was continued with stirring for another 30 minutes. The melt temperature increased to approximately 10° C. over the set temperature during the run. After 30 minutes, the rotors were stopped, and the resulting molten composite blend was discharged into an aluminum pie plate and cooled under ambient conditions. Once fully cooled and solidified, large chunks of the extrudate were granulated using a 3devo Shred-it polymer shredder.

Example 1D: Styrene-Ethylene-Butylene-Styrene:PZT Composites. Composites of PZT in styrene-ethylene-butylene-styrene (SEBS, Kraton G1657) were prepared in the above Haake mixer to afford composites having PZT loadings of 30 vol. %, 40 vol. %, 50 vol. %, and 60 vol. % in SEBS (Examples 1D-a, 1D-b, 1D-c and 1D-d, respectively). Other than the PZT loading, similar procedures were used to prepare each composite in the following manner. SEBS polymer pellets were first added to the mixer, and allowed to mix and melt for approximately 2 minutes under the conditions specified in Table 1 below. Nitrogen purge was not used in these experiments, and the mixer feed port remained open. The PZT particles were then added slowly. Once all the PZT had been added, the materials were mixed for 15 minutes more, and then discharged into a steel pan and cooled under ambient conditions. Once cooled and solidified, the extrudate was pulverized in a shredder mill and placed in a vacuum oven to keep dry.

TABLE 1

| | Mass | Mass | | Initial | Measured Melt | |
|---|---|---|---|---|---|---|
| | of | of | Vol. | Haake Set | Temperature | Yield of |
| Sample | SEBS | PZT | % | Temperature | During | composite |
| ID | (g) | (g) | PZT | (° C.) | Blending (° C.) | (g) |
| 1D-a | 18.0 | 230.0 | 60 | 240 | 255° C. | 236.0 |
| 1D-b | 22.5 | 191.7 | 50 | 235 | 248° C. | 199.5 |
| 1D-c | 27.0 | 153.4 | 40 | 230 | 244° C. | 171.7 |
| 1D-d | 31.5 | 115.0 | 30 | 227 | 239° C. | 132.5 |

Example 1E. Example 1E Thermoplastic Polyurethane (TPU):PZT Composites. A composite of PZT in thermoplastic polyurethane (TPU, BASF ELASTOLLAN 1190A10) was prepared in the above Haake mixer to afford composites having PZT loadings of 40 vol. %. The Haake mixer temperature was set to 190° C. TPU polymer pellets (34.4 g) were first added to the mixer and allowed to mix and melt for approximately 2 minutes. PZT particles (153.4 g) were then added slowly. Once all the PZT had been added, the materials were mixed for 10 minutes more and then discharged into an aluminum pan and cooled under ambient conditions.

Example 2: Piezoelectric Properties of Polymer:PZT Composites. Piezoelectric properties of 2 cm² square samples were evaluated by measuring d₃₃ values using an APC International Wide-Range d₃₃ meter. The d₃₃ meter is capable of measuring d₃₃ values between 1-2000 pC/N at an operating frequency of 110 Hz and an amplitude of 0.25 N. The d₃₃ value represents the quantity of charge generated when a piezoelectric material is subjected to a set applied force (amplitude). The samples tested were formed through injection molding or thermopressing. Injection molded samples were formed using a Minijector 45 and an aluminum mold. Further description of the samples and their piezoelectric properties are provided in Table 2 below. Prior to making the d₃₃ measurements, all samples were poled by a corona poling method in which the sample was exposed to a corona discharge for times ranging from 2 to 10 minutes. In the corona poling method, the sample was coated with silver paint on one side and exposed to a wire-generated corona. Since a surface area of approximately 300 μm² is exposed to the corona at a given time, the sample was moved to pole the complete surface through exposure to the corona. Variation in the poling process and routine sample-to-sample thickness inconsistencies may account for the variability in the d₃₃ values given in Table 2 below. Moreover, the poling process was not optimized.

TABLE 2

| | | Sample | Measured | Avg. d₃₃ | |
|---|---|---|---|---|---|
| | | Thickness | d₃₃ Values | Value (SD) | |
| Composite | Sample Type | (μm) | (pC/N) | (pC/N) | |
| 1:3 Polyamide:PZT | Inj. Molded | 1000 | 0.4, 0.5, 0.3 | 0.4 | (±0.1) |
| 1:3 Polyamide:PZT | Inj. Molded | 600 | 1.2, 2.1, 2 | 1.8 | (±0.5) |
| 60 vol. % PZT:SEBS | Thermopressed | 180 | 27, 16, 15, 22, | 20.6 | (±4.5) |
| | | | 23 | | |
| 50 vol. % PZT:SEBS | Thermopressed | 160 | 20, 17, 15, 23, | 18.6 | (±3.0) |
| | | | 19 | | |
| 40 vol. % PZT:SEBS | Thermopressed | 180 | 15, 17, 14, 15, | 16 | (±1.8) |
| | | | 19 | | |
| 30 vol. % PZT:SEBS | Thermopressed | 120 | 12, 9, 12, 16, | 20.6 | (±4.5) |
| | | | 13 | | |

A measurable piezoelectric response was obtained for each sample.

Example 3. Formation of PCL Powder Particulates Containing PZT. A 500 mL glass kettle reactor was loaded with 300 g 30k polydimethylsiloxane (PDMS) oil (Clearco, 30,000 cSt viscosity), 200 g of piezoelectric composite containing 40 vol. % PZT in PCL (prepared in a similar manner to Example 1B above), and 1.0 g AEROSIL RX50 silica (hydrophobically modified surface, average particle size=40 nm and a specific surface area of 25-45 m²/g, Evonik). The resulting mixture (40 wt. % solids) was heated at 140° C. with initial stirring at 300 RPM, followed by an additional 1 hour of stirring at 500 RPM once the temperature reached the 140° C. set point. Thereafter, heating and stirring were discontinued, and the slurry was allowed to cool to room temperature. The reaction mixture was diluted 3:1 (vol.) with heptane and stirred for 1 hour. The powder was collected by filtration and redispersed in heptane and stirred for a further 30 minutes. After redispersing in heptane and filtering a second time, powder particulates were collected.

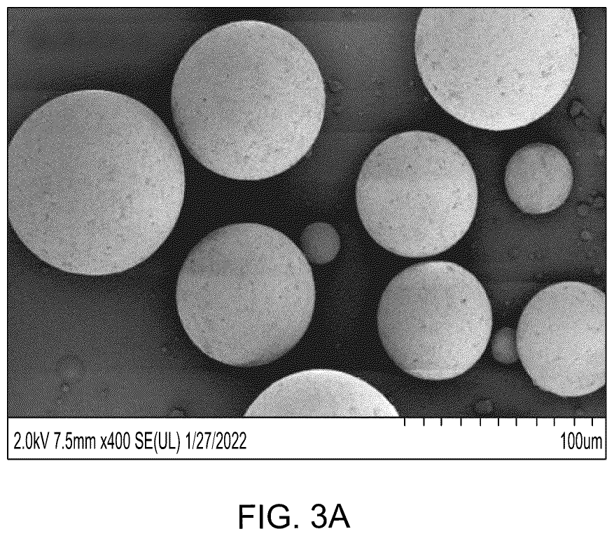

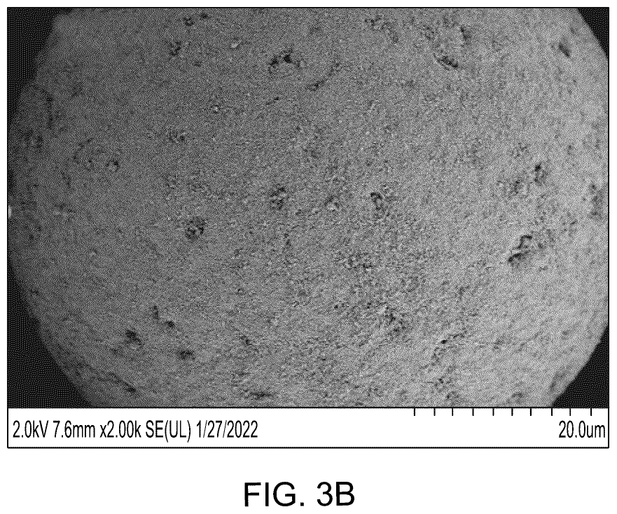

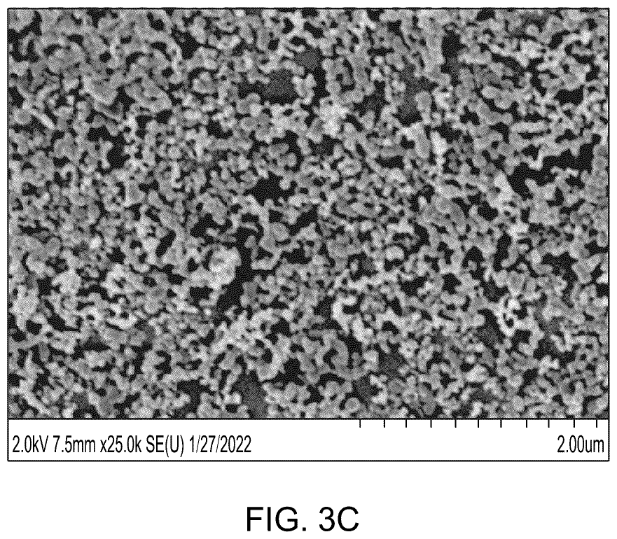

The resulting PCL:PZT powder particulates exhibited a D₅₀ value of 88 μm and a diameter span of 1.28. After sieving through a 150 μm sieve, 90% of the powder particulates were 150 μm or less in size. FIGS. 3A-3C are SEM images of PCL:PZT powder particulates at various magnifications. As shown in FIG. 3C, silica nanoparticles were localized upon the surface of the powder particulates.

Example 4. Formation of TPU Powder Particulates Containing PZT. A 500 mL glass kettle reactor was loaded with 280 g 60k polydimethylsiloxane (PDMS) oil (Clearco, 60,000 cSt viscosity), 120 g of piezoelectric composite containing 40 vol. % PZT in TPU (thermoplastic polyurethane) (prepared in a similar manner to Example 1E above), and 1.2 g AEROSIL RX50 silica (hydrophobically modified surface, average particle size=40 nm and a specific surface area of 25-45 m²/g, Evonik). The resulting mixture (30 wt. % solids) was heated at 240° C. with initial stirring at 300 RPM, followed by an additional 30 minutes of stirring at 500 RPM once the temperature reached the 240° C. set point. Thereafter, heating and stirring were discontinued, and the slurry was allowed to cool to room temperature. The reaction mixture was diluted 3:1 (vol.) with heptane and stirred for 1 hour. The powder was collected by filtration and redispersed in heptane and stirred for a further 30 minutes. After redispersing in heptane and filtering a second time, powder particulates were collected.

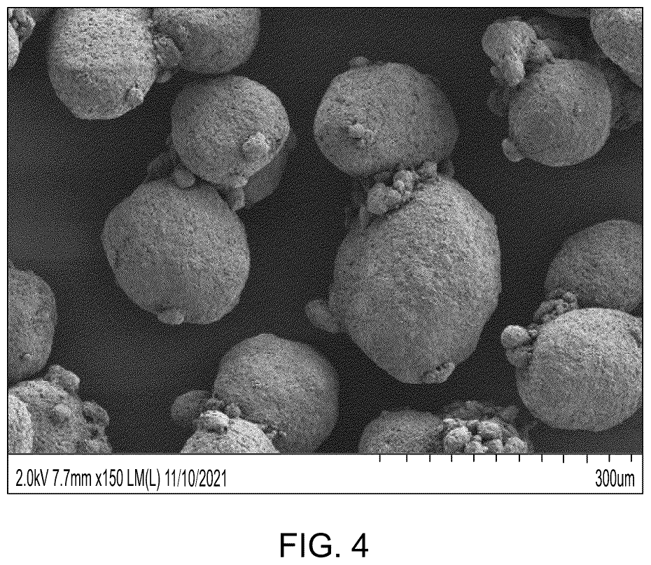

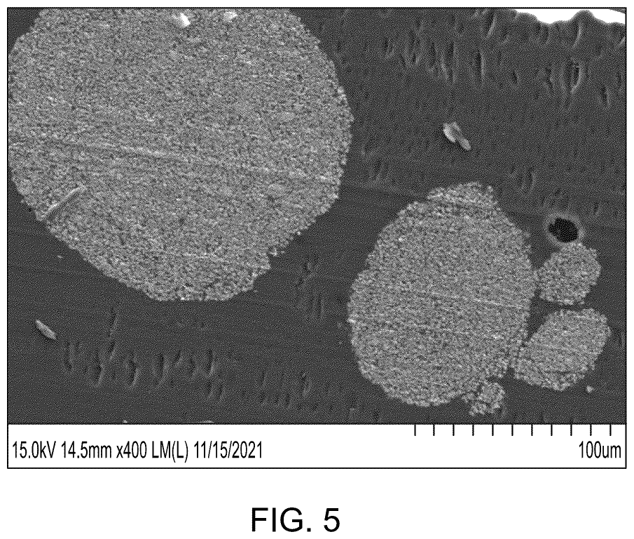

The resulting TPU:PZT powder particulates exhibited a D₅₀ value of 144 μm and a diameter span of 0.88. After sieving through a 150 μm sieve, 53.6% of the powder particulates were 150 μm or less in size. FIG. 4 is an SEM image of TPU:PZT powder particulates. The slightly reduced sphericity in this case is believed to arise from non-optimal process conditions. FIG. 5 is a cross-sectional SEM image of TPU:PZT powder particulates. As shown in FIG. 5, PZT particles were located within the interior (core) of the powder particulates.

Example 5: 3-D Printing of Powder Particulates. Particulate consolidation was conducted by laser sintering using a Sharebot SnowWhite SLS Printer. For PCL:PZT powder particulates, laser sintering was conducted at a laser power of 60%, a scan rate of 40,000, and a platen temperature of 108° C. For TPU:PZT powder particulates, laser sintering was conducted at a laser power of 70%, a scan rate of 20,000 and a platen temperature of 108° C. Both types of powder particulates were printed as 30 mm×30 mm squares having a thickness of approximately 60 microns.

Both the PCL:PZT and TPU:PZT sintered layers held together after removal from the powder bed and did not display appreciable voids. The surface roughness was 14.9±0.6 microns for PCL:PZT and 52±2 microns for TPU:PZT. No edge pull or warping of the printed layers was observed. Optical images (not shown) demonstrated that particle sintering occurred under the 3-D printing conditions.

Example 6: Piezoelectric Properties of 3-D Printed Samples. The printed layers from Example 5 were poled for 30 minutes at 80° C. using a voltage of 5 kV at an electrode distance of 1 mm. The electric field was maintained for 30 minutes while the sample was cooled to room temperature. Piezoelectric properties were then measured using a PM300 piezometer (Piezotest). The PCL:PZT printed layer exhibited a d₃₃ value of 8.7±0.2 pC/N, and the TPU:PZT printed layer exhibited a d₃₃ value of 3.2±0.1 pC/N.

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

One or more illustrative embodiments are presented herein. Not all features of a physical implementation are described or shown in this application for the sake of clarity. It is understood that in the development of a physical embodiment of the present disclosure, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for one of ordinary skill in the art and having benefit of this disclosure.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

1. A particulate composition comprising:
a plurality of powder particulates comprising a thermoplastic polymer and a plurality of piezoelectric particles, wherein the piezoelectric particles are located (i) in the thermoplastic polymer at an outer surface of the powder particulates, (ii) within a core of the powder particulates, or (iii) combinations thereof.

2. The particulate composition of claim 1, further comprising:
a plurality of nanoparticles disposed upon the outer surface of each of the plurality of powder particulates, the plurality of nanoparticles comprising a plurality of oxide nanoparticles, carbon black, carbon nanotubes, graphene, or any combination thereof.

3. The particulate composition of claim 2, wherein the plurality of oxide nanoparticles comprises a plurality of silica nanoparticles.

4. The particulate composition of claim 1, wherein the piezoelectric particles are substantially non-agglomerated.

5. (canceled)

6. The particulate composition of claim 1, wherein the piezoelectric particles have an average particle size of about 10 microns or less.

7. The particulate composition of claim 1, wherein the powder particulates comprise about 5 vol. % to about 85 vol. % piezoelectric particles.

8. (canceled)

9. The particulate composition of claim 1, wherein the piezoelectric particles comprise a piezoelectric material selected from the group consisting of lead zirconate titanate, doped lead zirconate titanate, barium titanate, lead titanate, lead magnesium niobate, lead magnesium niobate-lead titanate, sodium potassium niobate, calcium copper titanate, bismuth sodium titanate, gallium phosphate, quartz, tourmaline and any combination thereof.

10. The particulate composition of claim 1, wherein the powder particulates range from about 1 μm to about 500 μm in size.

11. (canceled)

12. (canceled)

13. (canceled)

14. (canceled)

15. (canceled)

16. (canceled)

17. (canceled)

18. An additive manufacturing process comprising:
depositing in a powder bed a particulate composition comprising a plurality of powder particulates comprising a thermoplastic polymer and a plurality of piezoelectric particles, wherein the piezoelectric particles are located (i) in the thermoplastic polymer at an outer surface of the powder particulates, (ii) within a core of the powder particulates, or (iii) combinations thereof; and
consolidating a portion of the plurality of powder particulates in the powder bed to form a printed object.

19. The additive manufacturing process of claim 18, wherein the plurality of powder particulates further comprise a plurality of nanoparticles disposed upon the outer surface of each of the plurality of powder particulates, the plurality of nanoparticles comprising a plurality of oxide nanoparticles, carbon black, carbon nanotubes, graphene, or any combination thereof.

20. (canceled)

21. The additive manufacturing process of claim 18, wherein the piezoelectric particles are substantially non-agglomerated.

22. The additive manufacturing process of claim 18, wherein the piezoelectric particles have an average particle size of about 10 microns or less.

23. (canceled)

24. (canceled)

25. The additive manufacturing process of claim 18, further comprising:
poling at least a portion of the printed object.

26. The additive manufacturing process of claim 18, wherein the powder particulates range from about 1 μm to about 500 μm in size.

27. A process for forming powder particulates, comprising:
providing a composite comprising a thermoplastic polymer and a plurality of piezoelectric particles distributed in the thermoplastic polymer;
combining the composite in a carrier fluid at a heating temperature at or above a melting point or softening temperature of the thermoplastic polymer;
wherein the thermoplastic polymer and the carrier fluid are substantially immiscible at the heating temperature;
applying sufficient shear to disperse the thermoplastic polymer as liquefied droplets containing the piezoelectric particles at the heating temperature;
after liquefied droplets have formed, cooling the carrier fluid to at least a temperature at which powder particulates in a solidified state form, the powder particulates comprising the thermoplastic polymer and at least a portion of the piezoelectric particles, wherein the piezoelectric particles are located (i) in the thermoplastic polymer at an outer surface of the powder particulates, (ii) within a core of the powder particulates, or (iii) combinations thereof; and
separating the powder particulates from the carrier fluid.

28. The process of claim 27, further comprising:
combining a plurality of nanoparticles with the composite in the carrier fluid, the plurality of nanoparticles comprising a plurality of oxide nanoparticles, carbon black, carbon nanotubes, graphene, or any combination thereof;
wherein at least a portion of the nanoparticles are disposed upon the outer surface of each of the powder particulates.

29. (canceled)

30. The process of claim 27, wherein the piezoelectric particles are substantially non-agglomerated.

31. The process of claim 27, wherein the piezoelectric particles have an average particle size of about 10 microns or less.

32. (canceled)

33. (canceled)

34. The process of claim 27, wherein the carrier fluid comprises a silicone oil.

35. The process of claim 27, wherein the powder particulates range from about 1 μm to about 500 μm in size.

36.-44. (canceled)
